(19) United States
(12) Patent Application Publication
(10) Pub. No.: US 2021/0103763 A1
(43) Pub. Date: Apr. 8, 2021

(54) METHOD AND APPARATUS FOR PROCESSING LASER RADAR BASED SPARSE DEPTH MAP, DEVICE AND MEDIUM

(71) Applicant: SHENZHEN SENSETIME TECHNOLOGY CO., LTD., Shenzhen (CN)

(72) Inventors: Junming FAN, Shenzhen (CN); Zixuan HUANG, Shenzhen (CN); Bogu ZHOU, Shenzhen (CN); Shuai YI, Shenzhen (CN); Hongsheng LI, Shenzhen (CN)

(21) Appl. No.: 17/126,837

(22) Filed: Dec. 18, 2020

Related U.S. Application Data
(63) Continuation of application No. PCT/CN2019/097270, filed on Jul. 23, 2019.

(30) Foreign Application Priority Data
Jul. 25, 2018 (CN) 201810829623.8

(51) Int. Cl. G06K 9/62; G06T 7/521; G01S 17/931; G01S 17/894; G06N 3/08

(52) U.S. Cl. CPC G06K 9/629; G06K 9/6232; G06T 7/521; G01S 17/931; G06T 2207/20081; G06N 3/08; G06T 2207/20084; G06T 2207/10028; G06T 2207/10044; G01S 17/894

(57) ABSTRACT

Provided are a method and apparatus for processing a laser radar based sparse depth map, a device and a medium. The method for processing a laser radar based sparse depth map includes: inputting, into a neural network, the laser radar based sparse depth map; and acquiring, by the neural network, at least two feature maps, each of a respective different scale, for the laser radar based sparse depth map, performing valid point feature fusion for each of the at least two feature maps of the different scales, and processing the at least two feature maps having subjected to the valid point feature fusion, to obtain a processed depth map, wherein a number of valid points in the processed depth map is greater than a number of valid points in the laser radar based sparse depth map.

### CROSS-REFERENCE TO RELATED APPLICATIONS

This application is a continuation of International Application No. PCT/CN2019/097270, filed on Jul. 23, 2019, which claims priority to Chinese patent application No. 201810829623.8, filed to the National Intellectual Property Administration, PRC on Jul. 25, 2018 and entitled “method and apparatus for processing laser radar based sparse depth map, Device and Medium”. The disclosures of International Application No. PCT/CN2019/097270 and Chinese patent application No. 201810829623.8 are hereby incorporated by reference in their entireties.

### TECHNICAL FIELD

The disclosure relates to computer vision technologies, and particularly to a method and apparatus for processing a laser radar based sparse depth map, a method and apparatus for intelligently controlling a vehicle, a method and apparatus for obstacle-avoiding navigation, a method and apparatus for training a neural network, an electronic device, a computer-readable storage medium and a computer program.

### BACKGROUND

A laser radar may acquire depth information of objects in a surrounding scene by scanning, and the depth information may form a laser radar projection map. The value of a point in the laser radar projection map generally denotes a depth value of the point. The laser radar projection map may also be referred to as a laser radar depth map.

The laser radar projection map may assist in tasks such as semantic segmentation and target detection, and may also be used in intelligent driving to analyze a scene around a vehicle and help to complete tasks such as making a vehicle control decision.

However, due to factors such as restriction in hardware conditions of the laser radar, the laser radar projection map often includes some invalid points, i.e., points having invalid depth values. Therefore, how to fill the depth values of the invalid points in the laser radar projection map to obtain an accurate laser radar depth map is a technical problem of concern.

### SUMMARY

Provided in embodiments of the disclosure are technical solutions for processing a laser radar based sparse depth map, for intelligently controlling a vehicle, for performing obstacle-avoiding navigation and for training a neural network.

According to one aspect of embodiments of the disclosure, provided is a method for processing a laser radar based sparse depth map, including: inputting, into a neural network, the laser radar based sparse depth map; and acquiring, by the neural network, at least two feature maps, each of a respective different scale, for the laser radar based sparse depth map, performing valid point feature fusion for each of the at least two feature maps of the different scales, and processing the at least two feature maps having subjected to the valid point feature fusion, to obtain a processed depth map, wherein a number of valid points in the processed depth map is greater than a number of valid points in the laser radar based sparse depth map.

According to another aspect of embodiments of the disclosure, provided is a method for intelligently controlling a vehicle, including: obtaining a processed depth map by using the method for processing a laser radar based sparse depth map of any above embodiment; and generating, according to the processed depth map, an instruction or early warning prompt information for controlling a vehicle where the laser radar is located.

According to another aspect of embodiments of the disclosure, provided is a method for obstacle-avoiding navigation, including: obtaining a processed depth map by using the method for processing a laser radar based sparse depth map of any above embodiment; and generating, according to the processed depth map, an instruction or early warning prompt information for performing obstacle-avoiding navigation control for a robot where the laser radar is located.

According to another aspect of embodiments of the disclosure, provided is a method for training a neural network, including: inputting a laser radar based sparse depth map sample into a neural network to be trained; acquiring, by the neural network to be trained, at least two feature maps, each of a respective different scale, for the laser radar based sparse depth map sample, performing valid point feature fusion for each of the at least two feature maps of the different scales, and processing the at least two feature maps having subjected to the valid point feature fusion, to form a processed depth map, wherein a number of valid points in the processed depth map is greater than a number of valid points in the laser radar based sparse depth map sample; and with the processed depth map and labelled depth values of a filled depth map sample for the laser radar based sparse depth map sample as guide information, performing supervised learning of the neural network to be trained.

According to another aspect of embodiments of the disclosure, provided is an apparatus for processing a laser radar based sparse depth map, including: a depth map input module, configured to input, into a neural network, the laser radar based sparse depth map; and a neural network, configured to acquire at least two feature maps, each of a respective different scale, for the laser radar based sparse depth map, perform valid point feature fusion for each of the at least two feature maps of the different scales, and process the at least two feature maps having subjected to the valid point feature fusion, to obtain a processed depth map, wherein a number of valid points in the processed depth map is greater than a number of valid points in the laser radar based sparse depth map.

According to another aspect of embodiments of the disclosure, provided is an apparatus for intelligently controlling a vehicle, including: a depth map input module, configured to input, into a neural network, a laser radar based sparse depth map; the neural network, configured to acquire at least two feature maps, each of a respective different scale, for the laser radar based sparse depth map, perform valid point feature fusion for each of the at least two feature maps of the different scales, and process the at least two feature maps having subjected to the valid point feature fusion, to obtain a processed depth map, wherein a number of valid points in the processed depth map is greater than a number of valid points in the laser radar based sparse depth map; and a control module, configured to generate, according to the processed depth map, an instruction or early warning prompt information for controlling a vehicle where the laser radar is located.

According to another aspect of embodiments of the disclosure, provided is an apparatus for obstacle-avoiding navigation, including: a depth map input module, configured to input, into a neural network, a laser radar based sparse depth map; the neural network, configured to acquire at least two feature maps, each of a respective different scale, for the laser radar based sparse depth map, perform valid point feature fusion for each of the at least two feature maps of the different scales, and process the at least two feature maps having subjected to the valid point feature fusion, to obtain a processed depth map, wherein a number of valid points in the processed depth map is greater than a number of valid points in the laser radar based sparse depth map; and an obstacle-avoiding navigation module, configured to generate, according to the processed depth map, an instruction or early warning prompt information for performing obstacle-avoiding navigation control for a robot where the laser radar is located.

According to another aspect of embodiments of the disclosure, provided is an apparatus for training a neural network, including: an depth map sample input module, configured to input a laser radar based sparse depth map sample into a neural network to be trained; the neural network to be trained, configured to: acquire at least two feature maps, each of a respective different scale, for the laser radar based sparse depth map sample, perform valid point feature fusion for each of the at least two feature maps of the different scales, and process the at least two feature maps having subjected to the valid point feature fusion, to form a processed depth map, wherein a number of valid points in the processed depth map is greater than a number of valid points in the laser radar based sparse depth map sample; and a supervision module, configured to: with the processed depth map and labelled depth values of a filled depth map sample for the laser radar based sparse depth map sample as guide information, perform supervised learning of the neural network to be trained.

According to another aspect of embodiments of the disclosure, provided is an apparatus for processing a laser radar based sparse depth map, including: a processor; and a memory, configured to store instructions that, when being executed by the processor, cause the processor to carry out the following: inputting, into a neural network, a laser radar based sparse depth map; and acquiring, by the neural network, at least two feature maps, each of a respective different scale, for the laser radar based sparse depth map, performing valid point feature fusion for each of the at least two feature maps of the different scales, and processing the at least two feature maps having subjected to the valid point feature fusion, to obtain a processed depth map, wherein a number of valid points in the processed depth map is greater than a number of valid points in the laser radar based sparse depth map.

According to another aspect of embodiments of the disclosure, provided is a non-transitory computer-readable storage medium having stored thereon computer programs that, when being executed by a computer, cause the computer to carry out the following: inputting, into a neural network, a laser radar based sparse depth map; and acquiring, by the neural network, at least two feature maps, each of a respective different scale, for the laser radar based sparse depth map, performing valid point feature fusion for each of the at least two feature maps of the different scales, and processing the at least two feature maps having subjected to the valid point feature fusion, to obtain a processed depth map, wherein a number of valid points in the processed depth map is greater than a number of valid points in the laser radar based sparse depth map.

According to another aspect of embodiments of the disclosure, provided is a computer program including computer instructions which, when running in a processor of a device, cause the processor to implement any method embodiment of the disclosure.

The technical solutions in the embodiments of the disclosure will be described in detail below through the drawings and the implementations.

### BRIEF DESCRIPTION OF THE DRAWINGS

The drawings forming a part of the specification depict the embodiments of the disclosure and, together with the description, serve to explain the principle of the embodiments of the disclosure.

Referring to the drawings, the embodiments of the disclosure may be understood more clearly according to the following detailed description. In the drawings:

FIG. 1 illustrates a flowchart of an implementation of a method for processing a laser radar based sparse depth map according to an embodiment of the disclosure.

FIG. 2 illustrates a schematic diagram of an implementation process of sparse upsampling according to an embodiment of the disclosure.

FIG. 3 illustrates a schematic diagram of an implementation process of sparse addition according to an embodiment of the disclosure.

FIG. 4 illustrates a schematic diagram of an implementation process of sparse merging and convolution according to an embodiment of the disclosure.

FIG. 5 illustrates a schematic diagram of an implementation of a bi-scale fusion module according to an embodiment of the disclosure.

FIG. 6 illustrates a schematic diagram of another implementation of a bi-scale fusion module according to an embodiment of the disclosure.

FIG. 7 illustrates a schematic diagram of an implementation of a tri-scale fusion module according to an embodiment of the disclosure.

FIG. 8 illustrates a schematic diagram of another implementation of a tri-scale fusion module according to an embodiment of the disclosure.

FIG. 9 illustrates a schematic diagram of an implementation of a neural network according to an embodiment of the disclosure.

FIG. 10 illustrates a schematic diagram of another implementation of a neural network according to an embodiment of the disclosure.

FIG. 11 illustrates a flowchart of an implementation of a method for training a neural network according to an embodiment of the disclosure.

FIG. 12 illustrates a flowchart of an implementation of a method for intelligently controlling a vehicle according to an embodiment of the disclosure.

FIG. 13 illustrates a flowchart of an implementation of a method for obstacle-avoiding navigation according to an embodiment of the disclosure.

FIG. 14 illustrates a schematic structural diagram of an implementation of an apparatus for processing a laser radar based sparse depth map according to an embodiment of the disclosure.

FIG. 15 illustrates a schematic structural diagram of an implementation of an apparatus for training a neural network according to an embodiment of the disclosure.

FIG. 16 illustrates a schematic structural diagram of an implementation of an apparatus for intelligently controlling a vehicle according to an embodiment of the disclosure.

FIG. 17 illustrates a schematic structural diagram of an implementation of an apparatus for obstacle-avoiding navigation according to an embodiment of the disclosure.

FIG. 18 illustrates a block diagram of an exemplary device for implementing an embodiment of the disclosure.

### DETAILED DESCRIPTION

Exemplary embodiments of the disclosure will now be described with reference to the drawings in detail. It is to be noted that relative arrangement of components and steps, numeric expressions and numeric values described in these embodiments do not limit the scope of the embodiments of the disclosure, unless otherwise indicated.

It is also to be understood that, in the embodiments of the disclosure, “multiple/a plurality of” may refer to two or more than two, and “at least one” may refer to one, two, or more than two.

Those skilled in the art may understand that the terms “first”, “second” and the like in the embodiments of the disclosure are merely for distinguishing different steps, devices or modules, etc., represent neither a special technical meaning nor a necessary logic sequence of items, and should not be construed as limits to the embodiments of the disclosure. It is also to be understood that, in the embodiments of the disclosure, “multiple/a plurality of” may refer to two or more than two, and “at least one” may refer to one, two, or more than two.

It is also to be understood that, for any component, data or structure mentioned in the embodiments of the disclosure, the number thereof can be understood to be one or more if there is no specific limits or opposite revelations are presented in the context. It is also to be understood that, in the embodiments of the disclosure, the descriptions about various embodiments are made with emphasis on differences between the embodiments and the same or similar parts may refer to each other and will not be elaborated for simplicity.

It is also to be understood that, for any component, data or structure mentioned in the embodiments of the disclosure, the number thereof can be understood to be one or multiple if there is no specific limits or opposite revelations are presented in the context.

In addition, it is to be understood that, for convenience of description, the size of each part shown in the drawings is not drawn according to a practical proportions.

The following description of at least one exemplary embodiment is merely illustrative in fact and in no way form any limit to the embodiments of the disclosure and application or use thereof.

Technologies, methods and devices known to those of ordinary skill in the art may not be discussed in detail, but the technologies, the methods and the devices should be considered as a part of the specification as appropriate.

It is to be noted that similar reference signs and letters represent similar terms in the following drawings and thus a certain term, once defined in a drawing, does not have to be further discussed in subsequent drawings.

Besides, in the embodiments of the disclosure, the term “and/or” is merely an association relationship for describing associated objects, and represents that three relationships may exist, for example, A and/or B may represent: A exists alone, A and B exist at the same time, and B exists alone. In addition, the character “/” in the embodiments of the disclosure generally indicates that the related objects are in an “or” relationship.

The embodiments of the disclosure may be applied to a terminal device, a computer system, a server and other electronic devices, which may operate together with numerous other universal or dedicated computing system environments or configurations. Examples of well-known terminal devices, computing systems, environments and/or configurations suitable for use together with the terminal device, computer system, server and other electronic devices include, but not limited to, a Personal Computer (PC) system, a server computer system, a thin client, a thick client, a handheld or laptop device, a microprocessor-based system, a set-top box, a programmable consumer electronic product, a network PC, a microcomputer system, a large-scale computer system, a distributed cloud computing technical environment including any abovementioned system, and the like.

The terminal device, computer system, server and other electronic devices may be described in a general context of computer system executable instructions (for example, program modules) executed by the computer system. Generally, the program module may include a routine, a program, a target program, a component, a logic, a data structure and the like that execute specific tasks or implement specific abstract data types. The computer system/server may be implemented in a distributed cloud computing environment, and in the distributed cloud computing environment, tasks are executed by a remote processing device connected through a communication network. In the distributed cloud computing environment, the program module may be in a storage medium of a local or remote computer system including a storage device.

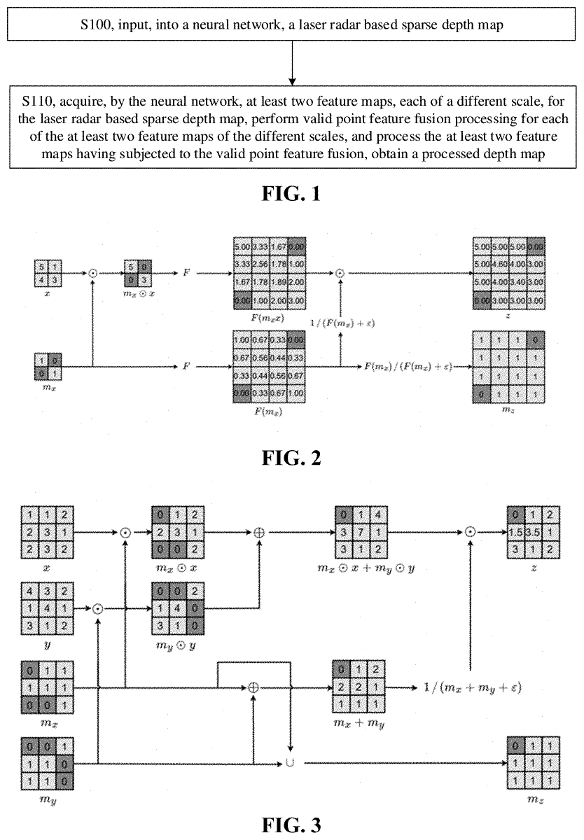

FIG. 1 illustrates a flowchart of a method for processing a laser radar based sparse depth map according to an embodiment of the disclosure. As illustrated in FIG. 1, the method of the embodiment includes the following operations.

In S100, a laser radar based sparse depth map is input into a neural network.

In embodiments of the disclosure, a depth map obtained based on a hardware device of a laser radar is referred to as a laser radar depth map. As some points in the depth map obtained based on the hardware device of the laser radar generally requires depth value filling, the depth map obtained based on the hardware device of the laser radar may be referred to as a laser radar based sparse depth map. A neural network in embodiment of the disclosure is a pre-trained neural network. In an optional example, the neural network may be obtained by training based on laser radar based sparse depth map samples and labelled depth values of filled depth map samples of the laser radar based sparse depth map samples.

In an optional example, the operation S100 may be executed by a processor by calling corresponding instructions stored in a memory, and may also be executed by a depth map input module 1400 operated by the processor.

In S110, the neural network acquires at least two feature maps, each of a respective different scale, for the laser radar based sparse depth map, performs valid point feature fusion for each of the at least two feature maps of the different scales, and processes the at least two feature maps having subjected to the valid point feature fusion, to obtain a processed depth map.

In an optional example, the operation S110 may be executed by the processor by calling corresponding instructions stored in a memory, and may also be executed by a neural network 1410 operated by the processor.

In embodiments of the disclosure, a depth map obtained by filling depth values of some points in a depth map obtained based on a laser radar hardware device is also a laser radar depth map, and may be referred to as a laser radar based dense depth map, a laser radar based complemented depth map, a filled laser radar depth map. In embodiments of the disclosure, a number of points having depth values in the processed laser radar depth map is greater than a number of points having depth values in the laser radar based sparse depth map. That is, “dense” is relative to the “sparse” in the embodiments of the disclosure.

In embodiments of the disclosure, a neural network is used to perform valid point feature fusion for each of the at least two feature maps of the different scales for the laser radar based sparse depth map, such that the neural network may implement feature fusion for multiple branches. Feature maps may be formed in the different branches during the sparse depth map processing on the basis of considering feature maps with different reception fields. Since global feature information (for example, feature information for characterizing a relation between objects) may be obtained easier based on feature maps of different reception fields, more accurate information of edges of objects may be obtained through the valid point feature fusion in the embodiments of the disclosure. Thus, the accuracy of feature maps having subjected to fusion can be improved, and the phenomenon of depth breakage of an object in an image can be avoided. Moreover, by means of the valid point feature fusion, influence on feature fusion by invalid points in the feature map may be avoided, so that the accuracy of the feature map having subjected to fusion may be improved. Since more accurate feature maps are used to form a processed depth map in the embodiments of the disclosure, the processed laser radar depth map may be more precise.

In the embodiments of the disclosure, the feature maps of the different scales often refer to feature maps of different sizes. One branch of the neural network corresponds to one respective scale. In the embodiments of the disclosure, the feature maps of the different scales may express different reception fields.

In an optional example, the laser radar depth map in the embodiments of the disclosure may be a depth map formed, through scanning and projecting, by a laser radar installed in devices such as a vehicle or a monitoring apparatus. For example, the laser radar generates depth point cloud data by scanning, and when the depth point cloud data is projected to a two-dimensional plane of an image (such as a Red Green Blue (RGB) image and an Infrared Radiation (IR) image) photographed by a photographic device, a laser radar projection map (which may also be referred to as a two-dimensional laser radar projection map) is formed. The laser radar projection may provide depth values for points in the image photographed by the photographic device. The laser radar projection map may have the same or basically same (close) angle of view and size as the image photographed by the photographic device. In the following description, an RGB image is sometimes taken as an example of the image photographed by the photographic device, to describe the embodiments of the disclosure. However, it should be known that it is also feasible to replace the RGB image in the following description with other types of images such as an IR image.

In an optional example, due to factors such as restriction in hardware conditions of the laser radar, the laser radar projection often can only provide depth values for a part of points in the image photographed by the photographic device. Therefore, the laser radar projection map is also referred to as a laser radar based sparse depth map. Points having depth values in the laser radar based sparse depth map may be referred to as valid points, and point having no depth value may be referred to as invalid points.

In an optional example, as the feature fusion operation executed by the neural network in the embodiments of the disclosure is feature fusion for valid points, it is necessary for the neural network to distinguish whether each point in the feature map is a valid point during feature fusion. In the embodiments of the disclosure, the neural network may use a mask for the feature map to distinguish valid points from invalid points. The neural network may also distinguish valid points from invalid points in the feature map in other means. The implementation of distinguishing valid points from invalid points in a feature map is not limited in the embodiments of the disclosure.

In some implementations, in operation S100, a laser radar based sparse depth map and a mask for the laser radar based sparse depth map may be input to a neural network. The mask for the laser radar based sparse depth map is configured to indicate valid points in the laser radar based sparse depth map. Correspondingly, the implementation may further include that: a mask is determined for each of at least two feature maps of the different scales according to the mask for the laser radar based sparse depth map. In the operation S110, when valid point feature fusion is performed for each of the at least two feature maps of the different scales, the valid point feature fusion may be performed for each of the at least two feature maps of the different scales according to the masks for the at least two feature maps of the different scales.

In an optional example, while the laser radar based sparse depth map is provided to the neural network in the embodiments of the disclosure, the mask for the laser radar based sparse depth map may also be provided to the neural network. The mask for the laser radar based sparse depth map may indicate valid points in the laser radar based sparse depth map. For example, if a point in the mask has a value of 0, it is indicated that the point in the laser radar based sparse depth map is an invalid point. If a point in the mask has a value of 1, it is indicated that the point in the laser radar based sparse depth map is a valid point. In the embodiments of the disclosure, valid points may be distinguished from invalid points in the laser radar based sparse depth map conveniently by use of the mask for the laser radar based sparse depth map.

In an optional example, the neural network in the embodiments of the disclosure executes an operation of processing an input, a fusion operation and an operation of processing for output. In the following description, for convenience of description, the part executing the operation of processing an input in the neural network is referred to as an input processing unit, the part executing the fusion operation in the neural network is referred to as a fusion module, and the part executing the operation of processing for output in the neural network is referred to as an output processing unit. The neural network in the embodiments of the disclosure may include: an input processing unit, at least one fusion module having multiple paths of inputs and outputs, and an output processing unit. In the case where the neural network includes multiple fusion modules, the fusion modules are sequentially and serially connected between the input processing unit and the output processing unit, i.e., an output of a level of fusion module serves as an input for another level of fusion module immediately following the level of fusion module.

In some implementations, the operation S110 that the neural network acquires the at least two feature maps of the different scales for the laser radar based sparse depth map may include that: the neural network performs sparse convolution on the laser radar based sparse depth map to obtain a feature map for the laser radar based sparse depth map; and performs scale conversion on the feature map of the depth map to obtain the at least two feature maps of the different scales. The at least two feature maps of the different scales includes: the feature map having not subjected to the scale conversion and at least one feature map having subjected to the scale conversion.

In addition, in other some implementations, when the masks for the at least two feature maps of the different scales are determined according to the mask for the laser radar based sparse depth map, the neural network may perform sparse convolution on the mask for the laser radar based sparse depth map to obtain a mask for the feature map of the laser radar based sparse depth map, and performing scale conversion on the mask for the feature map, to obtain a mask for each of the at least two feature maps.

In an optional example, the input processing unit is mainly configured to perform sparse convolution on the laser radar based sparse depth map, to obtain the feature map for the laser radar based sparse depth map, and perform scale conversion on the feature map for the depth map, to obtain multiple (including two) feature maps each of a respective different scale, including the feature map of the depth map. For example, the input processing unit performs processing (such as downsampling) on the feature map for the depth map, such that the input processing unit may provide two, or three, or more feature maps, each of a respective different scale, for the first level of fusion module adjacent to the input processing unit. In the case where the mask for the laser radar based sparse depth map is also input to the neural network, the input processing unit in the embodiments of the disclosure may further be configured to perform sparse convolution on the mask for the laser radar based sparse depth map, to obtain a mask for the feature map for the laser radar based sparse depth map. The input processing unit may further perform corresponding scale conversion on the sparse convolution processed mask, to obtain a mask for each feature map to be provided to the first level of fusion module. For example, the input processing unit correspondingly downsamples the sparse convolution processed mask for the feature map for the depth map, such that the input processing unit may provide masks for two or three or more feature maps, each of a respective different scale, for the first level of fusion module. The masks for the feature maps are configured to indicate the valid points in the corresponding feature maps. For example, if a point in a mask has the value of 0, it is indicated that the point in the corresponding feature map is an invalid point. If the point in the mask has the value of 1, it is indicated that the point in the corresponding feature map is a valid point.

The sparse convolution in the embodiments of the disclosure generally refers to: for a map including valid points and invalid points (such as a laser radar based sparse depth map or a mask for the laser radar based sparse depth map), weighted convolution operation is performed at a position of a valid point and a position of an invalid point in the map (such as the laser radar based sparse depth map or the mask for the laser radar based sparse depth map). In the embodiments of the disclosure, with the sparse convolution, a feature map of the laser radar based sparse depth map and a mask for the feature map may be obtained conveniently.

In an optional example, each fusion module included in the neural network in the embodiments of the disclosure includes multiple (at least two) inputs and multiple (at least two) outputs, and a fusion module generally has the same number of inputs and outputs. The fusion module is mainly configured to respectively perform valid point feature fusion on the feature maps of the different scales in the multiple inputs. During the feature fusion, with consideration of the masks for the feature maps, the fusion module may conveniently distinguish valid points from invalid point in the feature map, so as to conveniently implement the feature fusion of the valid points.

In some implementations, the operation S110 that the valid point feature fusion is performed for the at least two feature maps of the different scales may include that: the neural network executes at least one level of valid point feature fusion; and during the at least one level of valid point feature fusion, the neural network performs valid point feature fusion on feature maps of different scales in multiple paths; and in the case where the neural network executes multiple levels of valid point feature fusion, an output from a level of fusion is provided as an input for another level of fusion immediately following the level of fusion.

In an optional example, in the case where the neural network in the embodiments of the disclosure includes multiple fusion modules, the neural network may perform scale conversion for a feature map in at least one path of output from a level of fusion module, such that a feature map of a respective scale is provided for each path of input of another level of fusion module immediately following the level of fusion module.

The neural network performs scale conversion for the feature map output by a level of fusion, and the feature map having subjected to the scale conversion is provided to another level of fusion immediately following the level of fusion. For example, a feature map formed by performing scale conversion on the feature map in a path of output for a level of fusion module serves as a feature map in a path of input for another level of fusion module immediately after the level of fusion module.

In the case where the number of paths of outputs from a level of fusion is smaller than the number of paths of inputs for another level of fusion immediately following the level of fusion, a path of output from the level of fusion and a feature map in the path of output having subjected to the scale conversion both serve as inputs for the another level of fusion. For example, in the case where the number of paths of outputs from a level of fusion module is smaller than the number of paths inputs for another level of fusion module immediately following the level of fusion module, while a path of output from the level of fusion module serves as a path of input for the another level of fusion module, a feature map formed by performing scale conversion on a feature map in the path of output serves as a feature map of another path of input for the another level of fusion module.

It is to be particularly noted that while performing scale conversion on a feature map in the embodiments of the disclosure, scale conversion may also be performed on a mask for the feature map correspondingly, such that the feature map having subjected to the scale conversion corresponds to a mask.

In an optional example, for convenience of description, the part for performing the scale conversion operation on the feature map output by the fusion module in the neural network may be referred to as a first conversion module in the embodiments of the disclosure. In the embodiments of the disclosure, the first conversion module may also be used to perform scale conversion on the mask for the feature map output by the fusion module. The neural network in the embodiments of the disclosure may include at least one first conversion module; and the first conversion module may implement scale conversion on the feature map and the mask for the feature map by executing downsampling or sparse upsampling operation. The sparse upsampling in the embodiments of the disclosure generally refers to: for a map including valid points and invalid points (such as a feature map or a mask for the feature map), weighted upsampling operation is performed according a position of a valid point and a position of an invalid point in the map (such as the feature map or the mask for the feature map). In the embodiments of the disclosure, with the sparse upsampling, the scale conversion for the feature map and the mask for the feature map may be implemented conveniently.

In an optional example, the sparse upsampling may include that: element-wise multiplication is performed on a feature map and a mask for the feature map, and a multiplication result is upsampled; the mask for the feature map is upsampled, and a weight matrix is formed based on the upsampled mask; element-wise multiplication is performed on the upsampled feature map and a reciprocal of the weight matrix to form a feature map having subjected to sparse addition; and the weight matrix is binarized to form a mask for the feature map having subjected to the sparse addition.

The downsampling operation in the embodiments of the disclosure may be implemented by max pooling. Of course, the downsampling operation may also be realized in other means in the embodiments of the disclosure, and the implementation process of the downsampling operation is not limited in the embodiments of the disclosure. In the embodiments of the disclosure, when sparse upsampling operation is executed on the feature map, reference may be made to the mask for the feature map, such that the positions of the valid points in the feature map having subjected to sparse upsampling may be decided by the positions of the valid points in the feature map before the sparse upsampling. The implementation process of sparse upsampling may refer to the following description about FIG. 2.

In some other implementations, the operation S110 that valid point feature fusion is performed for each of the at least two feature maps of the different scales may further include that: valid point feature fusion is performed for at least two feature maps having subjected to valid point feature fusion, to form one feature map. The formed feature map serves as an input for an immediately following level of valid point fusion, or, the neural network processes the formed feature map, for output.

Additionally, in another embodiment, the method for processing a laser radar based sparse depth map provided in the embodiments of the disclosure may further include that: an image having a same angle of view and a same size as the laser radar based sparse depth map is provided to the neural network, the image including an image photographed by a photographic device; and the neural network acquires at least one feature map of a respective scale for the image. The at least one feature map of the respective scale for the image serves as an input for corresponding valid point feature fusion. The at least one feature map for the image is to be fused with a feature map for the laser radar based sparse depth map.

In an optional example, in the case where the neural network in the embodiments of the disclosure includes multiple fusion modules, the neural network may perform valid point feature fusion on feature maps in at least two paths of outputs from a level of fusion module, to form one feature map. The formed feature map may serve as an input for another level of fusion module immediately following the level of fusion module. For example, in the case where the number of paths of outputs from a level of fusion module is greater than the number of paths of inputs for another level of fusion module immediately following the level of fusion module, a feature map formed by valid point feature fusion performed on two paths of outputs from the level of fusion module serves as a feature map of a path of input for the another level of fusion module.

It is to be particularly noted that while valid point feature fusion is performed on the feature map output by the level of fusion module in the embodiments of the disclosure, corresponding fusion may further be performed on the mask for the feature map, such that the feature map having subjected to fusion is provided with a mask.

In some implementations, the operation that the neural network processes the formed feature map, for output may include that: sparse addition is performed on multiple feature maps and masks having subjected to valid point feature fusion output by a final level of fusion, and convolution is performed on a result of the sparse addition to form a processed depth map.

In an optional example, the sparse addition may include that: element-wise multiplication is performed on a first feature map and a mask for the first feature map, element-wise multiplication is performed on a second feature map and a mask for the second feature map, two multiplication results are added, and element-wise multiplication is performed on an addition result and a reciprocal of a weight matrix to form a feature map having subjected to sparse addition; and OR operation is performed on the mask for the first feature map and the mask for the second feature map to form a mask for the feature map having subjected to sparse addition.

In an optional example, for convenience of description, the part, in the neural network, for performing valid point feature fusion for feature maps in at least two paths of outputs from a level of fusion module may be referred to as a second conversion module in the embodiments of the disclosure. In the embodiments of the disclosure, the second conversion module may also be used to perform fusion on the masks for the feature maps in the at least two paths of outputs from the level of fusion module. The neural network in the embodiments of the disclosure may include at least one second conversion module; and the second conversion module may implement the valid point feature fusion for the feature maps and the fusion of the masks mentioned above by operations such as sparse upsampling and sparse addition. The sparse addition in the embodiments of the disclosure generally refers to: for a map including valid points and invalid points (such as a feature map or a mask for the feature map), weighted addition operation is performed at a position of a valid point and a position of an invalid point in the map (such as the feature map or the mask for the feature map). In the embodiments of the disclosure, with sparse upsampling and sparse addition, valid point feature fusion for feature maps and fusion of masks for the feature maps may be implemented conveniently.

In the embodiments of the disclosure, when sparse upsampling and sparse addition are performed on feature maps, reference may be made to masks for the feature maps, so as to implement the sparse upsampling and the sparse addition based on valid points. Thus, positions of valid points in the feature map having subjected to sparse upsampling and sparse addition are decided by positions of valid points in the feature map having not subjected to the sparse upsampling. One example of the implementation process of sparse addition may refer to the following description about FIG. 3.

It is to be particularly noted that in an application scene, a first conversion module may be provided between a former fusion module and a latter fusion module adjacent to each other. In another application scene, a second conversion module may be provided between the former fusion module and the latter fusion module adjacent to each other. In still another application scene, a first conversion module and a second conversion module may be provided between the former fusion module and the latter fusion module adjacent to each other.

In an optional example, the valid point feature fusion operation executed for each path of input of the fusion module in the neural network is not completely the same. For example, in the case where the fusion module includes two inputs, the fusion module performs different valid point feature fusion operations for the two inputs. For another example, in the case where the fusion module includes three inputs, the fusion module may perform the same valid point feature fusion operation for two of the inputs, which is different from the valid point feature fusion operation executed for the rest one of the inputs. Of course, the possibility that the fusion module performs three different valid point feature fusion operations for the three inputs respectively is not excluded from the embodiments of the disclosure.

In some implementations, in the case where the fusion includes N paths of inputs and outputs, the valid point feature fusion operation executed on an M^{th} path of input by the neural network may include that: a feature map and mask in an N^{th} path of input are downsampled; sparse merging and convolution is performed on the downsampled feature map and mask, and a feature map and mask in an M^{th} path of input; sparse convolution is performed on the feature map and mask having subjected to sparse merging and convolution, to form a feature map and mask having subjected to valid point feature fusion for an M^{th} path of output. A scale of the feature map in the N^{th} path of input is greater than a scale of the feature map in the M^{th} path of input. M is an integer greater than 0. N is an integer greater than N.

In an optional example, in the case where the fusion module includes N (N>1, and N is an integer) paths of inputs and outputs, the valid point feature fusion process executed for an M^{th} path of input (M>0, and M is an integer smaller than the N) by the fusion module may be as follows.

First of all, the fusion module performs processing (such as downsampling) on a feature map and mask in an N^{th} path of input. For example, downsampling of the feature map in the N^{th} path of input is realized by max pooling. Moreover, the fusion module may implement the downsampling of the mask for the feature map in the N^{th} path of input by max pooling. In the example, the scale of the feature map in the N^{th} path of input is greater than that of the feature map in the M^{th} path of input.

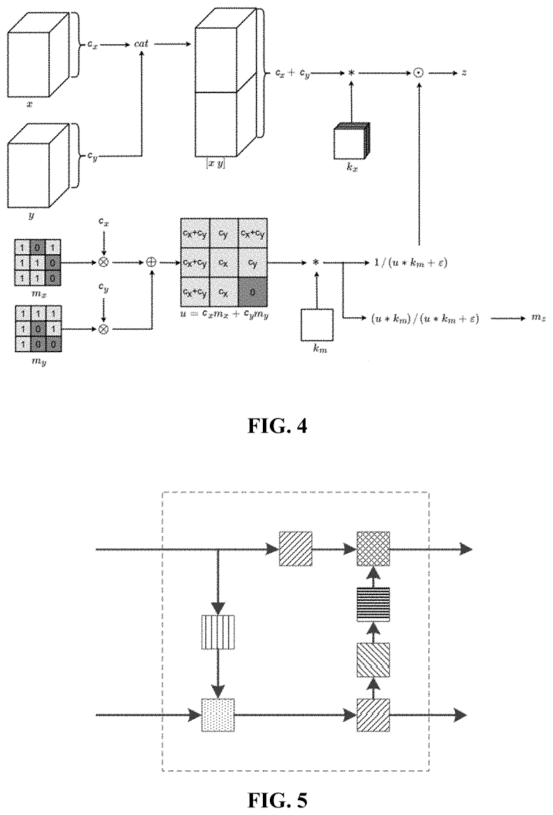

Then, the fusion module performs sparse merging and convolution on the downsampled feature map and mask, and the feature map and mask in the M^{th} path of input, so as to obtain a feature map and mask having subjected to sparse merging and convolution. The sparse merging and convolution in the embodiments of the disclosure generally refers to: merging two paths of maps (such as the feature maps or the masks) including valid points and invalid points, and performing weighted convolution operation according to positions of the valid points and positions of the invalid points in a merged map (such as the merged feature map or merged mask). In the embodiments of the disclosure, with the sparse merging and convolution, the feature map and mask having subjected to valid point feature fusion may be formed conveniently for the M^{th} path. One example of the implementation process of sparse merging and convolution may refer to the following description about FIG. 4.

At last, the fusion module performs sparse convolution on the feature map and mask having subjected to sparse merging and convolution, to form a feature map and mask having subjected to valid point feature fusion for the M^{th} path of output. An existing sparse convolution mode may be used in the embodiments of the disclosure. The implementation process of sparse convolution is not limited in the embodiments of the disclosure.

In some other implementations, valid point feature fusion executed on the N^{th} path of input by the neural network may include that: sparse convolution is performed on a feature map and mask in the N^{th} path of input; convolution is performed on a feature map and mask having subjected to valid point feature fusion in at least an M^{th} path of output, and sparse upsampling is performed on the feature map and mask having subjected to the convolution; and sparse addition is performed on the feature map and mask having subjected to the sparse convolution in the N^{th} path, and the feature map and mask having subjected to upsampling in at least the M^{th} path, to form a feature map and mask having subjected to valid point feature fusion for the N^{th} path of output.

In some other implementations, in the case where the fusion includes N paths of inputs and outputs, valid point feature fusion executed on an N^{th} path of input by the neural network may include that: sparse merging and convolution is performed on a feature map and mask in an N^{th} path of input, and a feature map of an image; convolution is performed on the feature map and mask having subjected to valid point feature fusion in at least the M^{th} path of output, and sparse upsampling is performed on the feature map and mask having subjected to convolution; and sparse addition is performed on the feature map and mask having subjected to sparse merging and convolution in the N^{th} path, and the sparse upsampled feature map and mask at least in the M^{th} path, to form a feature map and mask having subjected to valid point feature fusion for an N^{th} path of output. M is an integer greater than 0, and N is an integer greater than M.

Correspondingly, in some implementations, the operation that the neural network processes the formed feature map, for output may include that: sparse addition is performed on feature maps and masks having subjected to valid point feature fusion output by a final level of fusion, sparse merging and convolution is performed on a sparse addition result and the feature map of the image, and convolution is performed on a result of the sparse merging and convolution to form a processed depth map.

In an optional example, in the case where the fusion module includes N (N>1, and the N is an integer) paths of inputs and outputs, a valid point feature fusion process executed on an N^{th} path of input by the fusion module may be as follows.

First of all, the fusion module performs sparse convolution on a feature map and mask in the N^{th} path of input. Likewise, an existing sparse convolution mode may be used in the embodiments of the disclosure. The implementation process of sparse convolution is not limited in the embodiments of the disclosure.

Then, the fusion module performs convolution on a feature map and mask having subjected to valid point feature fusion in at least an M^{th} path of output (M>0, and M being an integer smaller than the N), and performs sparse upsampling on the feature map and mask having subjected to the convolution. For example, in the case where the fusion module includes three paths of inputs and outputs, the fusion module may only perform convolution and sparse upsampling on the feature map and mask in a first path of output. For another example, in the case where the fusion module includes three paths of inputs and outputs, the fusion module may only perform convolution and sparse upsampling on the feature map and mask in a second path of output. For another example, in the case where the fusion module includes three paths of inputs and outputs, the fusion module may perform convolution and sparse upsampling on the feature map and mask in a first path of output, and perform convolution and sparse upsampling on the feature map and mask in a second path of output.

At last, the fusion module performs sparse addition on the feature map and mask having subjected to sparse convolution in the N^{th} path, and the feature map and mask having subjected sparse upsampling in at least the M^{th} path, thereby forming a feature map and mask having subjected to valid point feature fusion for an N^{th} path of output. For example, in the case where the fusion module includes three paths of inputs and outputs, the fusion module may perform sparse addition on a feature map and mask having subjected to sparse convolution in the third path, and a feature map and mask having subjected to sparse upsampling in the first path. The feature map and mask having subjected to the sparse addition serve as a third path of output for the fusion module. For another example, in the case where the fusion module includes three paths of inputs and outputs, the fusion module may perform sparse addition on the feature map and mask having subjected to sparse convolution in the third path, and the feature map and mask having subjected to sparse upsampling in the second path. The feature map and mask having subjected to the sparse addition serve as a third path of output for the fusion module. For another example, in the case where the fusion module includes three paths of inputs and outputs, the fusion module may perform sparse addition on a feature map and mask having subjected to sparse convolution in the third path, and a feature map and mask having subjected to sparse upsampling in the first path, and further perform sparse addition on the feature map and mask having subjected to the sparse addition, and a feature map and mask having subjected to sparse upsampling in the second path. The final obtained feature map and mask having subjected to the sparse addition serve as the third path of output.

In an optional example, while the laser radar based sparse depth map and mask are provided to the neural network in the embodiments of the disclosure, an RGB image corresponding to the sparse depth map may also be provided to the neural network. The RGB image generally has the same or basically same angle of view and a same size as the laser radar based sparse depth map. For example, the laser radar generates depth point cloud data by scanning, and the depth point cloud data is projected to the RGB image photographed by the photographic device, thereby forming a laser radar based sparse projection map.

In an optional example, the input processing unit of the neural network may further be configured to acquire at least one feature map of a respective scale for the RGB image. The number of feature maps for the RGB image that are acquired by the input processing unit is generally smaller than the number of fusion modules included in the neural network. In the embodiments of the disclosure, by providing a feature map of a respective scale for an RGB image to a corresponding fusion module in the neural network, the fusion module may perform valid point feature fusion operation by referring to the received feature map for the RGB image.

As the feature map of the RGB image may provide global feature information (such as feature information for characterizing a relationship between objects) for the fusion module, the fusion module may obtain more accurate object edge information in the embodiments of the disclosure. The phenomenon of depth breakage of an object in an image can be avoided, and the processed laser radar depth map is more precise.

In an optional example, in the case where the fusion module includes N (N>0, and N is an integer) paths of inputs and outputs, and the feature map of the RGB image is provided to the fusion module, a valid point feature fusion process executed by the fusion module for an M^{th} path of input (M>0, and M is an integer smaller than N) may refer to the description in the above implementation. Description will not be made herein again.

In an optional example, in the case where the fusion module includes N (N>0, and N is an integer) paths of inputs and outputs, and the feature map of the RGB image is provided to the fusion module, a valid point feature fusion process executed on an N^{th} path of input by the fusion module may be as follows.

First of all, the fusion module performs sparse merging and convolution on a feature map and map in the N^{th} path of input.

Then, the fusion module performs convolution on a feature map and mask having subjected to valid point feature fusion in at least an M^{th} path of output, and performs sparse upsampling on the feature map and mask having subjected to the convolution. For example, in the case where the fusion module includes three paths of inputs and outputs, the fusion module may only perform convolution and sparse upsampling on the feature map and mask in a first path of output. For another example, in the case where the fusion module includes three paths of inputs and outputs, the fusion module may only perform convolution and sparse upsampling on the feature map and mask in a second path of output. For another example, in the case where the fusion module includes three paths of inputs and outputs, the fusion module may perform convolution and sparse upsampling on the feature map and mask in a first path of output, and perform convolution and sparse upsampling on the feature map and mask in a second path of output.

At last, the fusion module performs sparse addition on the feature map and mask having subjected to sparse merging and convolution in the N^{th} path, and the feature map and mask having subjected to sparse upsampling in at least the M^{th} path, thereby forming a feature map and mask having subjected to valid point feature fusion for an N^{th} path of output. For example, in the case where the fusion module includes three paths of inputs and outputs, the fusion module may perform sparse addition on a feature map and mask having subjected to sparse merging and convolution in the third path, and a feature map and mask having subjected to sparse upsampling in the first path. The feature map and mask having subjected to the sparse addition serve as the third path of output for the fusion module. For another example, in the case where the fusion module includes three paths of inputs and outputs, the fusion module may perform sparse addition on the feature map and mask having subjected to sparse merging and convolution in the third path, and a feature map and mask having subjected to sparse upsampling in the second path. The feature map and mask having subjected to the sparse addition serve as the third path of output for the fusion module. For another example, in the case where the fusion module includes three paths of inputs and outputs, the fusion module may perform sparse addition on the feature map and mask having subjected to sparse merging and convolution in the third path, and a feature map and mask having subjected to sparse upsampling in the first path, and further perform sparse addition on the present feature map and mask having subjected to the sparse addition, and a feature map and mask having subjected to sparse upsampling in the second path. The final obtained feature map and mask having subjected to the sparse addition serve as the third path of output for the fusion module.

In an optional example, the output processing unit in the embodiments of the disclosure is mainly configured to form a processed (i.e., filled) depth map according to an output of a final level of fusion module.

In the case where the RGB image is not provided to the neural network as an input, the output processing unit may be a first output processing unit. The first output processing unit is mainly configured to perform sparse addition on multiple paths of feature maps and masks having subjected to valid point feature fusion output by the final level of fusion module, and perform convolution on a result of the sparse addition, to form a processed depth map.

In the case where the RGB image is provided to the neural network as an input, the output processing unit may be a second output processing unit. The second output processing unit is mainly configured to perform sparse addition on multiple paths of feature maps and masks having subjected to valid point feature fusion output by the final level of fusion module, perform sparse merging and convolution on a result of the sparse addition and the feature map of the RGB image, and perform convolution on a result of the sparse merging and convolution, to form a processed depth map.

In an optional example of the embodiments of the disclosure, the implementation process of sparse upsampling is as illustrated in FIG. 2.

In FIG. 2, the 2×2 matrix located at the upper left corner denotes a feature map x. The 2×2 matrix located at the lower left corner denotes a mask mₓ for the feature map x. The character ⊙ denotes element-wise multiplication. The character ⊕ denotes element-wise addition. The character “/” denotes element-wise division. F denotes upsampling.

First of all, element-wise multiplication is performed on the feature map x and the mask mₓ, obtaining a multiplication result as the second 2×2 matrix in the first row counting from the upper left corner in FIG. 2, i.e., the 2×2 matrix located above mₓ⊙x. The multiplication result mₓ⊙x is upsampled to form the first 4×4 matrix in the first row counting from the upper left corner, i.e., the 4×4 matrix located above (mₓ, x).

Then, the mask mₓ for the feature map x is upsampled to form the first 4×4 matrix in the second row counting from the lower left corner, i.e., the 4×4 matrix located above F(mₓ). A weight matrix is formed based on the upsampled mask F(mₓ). One example of a reciprocal of the weight matrix may be: 1/(F(mₓ)+ε), where the ε is a constant far smaller than 1. For example, the value of ε may range within 0.00005-0.0001. The ε is mainly used to prevent the denominator from being 0.

Next, element-wise multiplication is performed on the upsampled feature map F(mₓ, x) and the reciprocal 1/(F(mₓ)+ε) of the weight matrix to form the feature map z having subjected to sparse addition (as illustrated at the upper right corner of FIG. 2).

At the meantime, the weight matrix F(mₓ) may be binarized to form a mask m_{z} (as illustrated at the lower right corner of FIG. 2) for the feature map having subjected to sparse addition. One example of binarization for the weight matrix in the embodiments of the disclosure may be represented as: F(mₓ)/(F(mₓ)+ε).

In the embodiments of the disclosure, the following formula (1) may be used to represent the sparse upsampling for the feature map, and the following formula (2) may be used to represent the sparse upsampling for the mask of the feature map:

z=F(mₓ⊙x)/(F(mₓ)+ε) Formula (1)

m_{z}=F(mₓ)/(F(mₓ)+ε) Formula (2)

In an optional example of the embodiments of the disclosure, the implementation process of sparse addition is as illustrated in FIG. 3.

In FIG. 3, the 3×3 matrix located at the upper left corner denotes a feature map x, the 3×3 matrix located below the feature map x denotes a feature map y, the 3×3 matrix located below the feature map y denotes a mask mₓ for the feature map x, the 3×3 matrix located below the mask mₓ for the feature map x denotes a mask m_{y} for the feature map y. The character ⊙ denotes element-wise multiplication. The character ⊕ denotes element-wise addition. The character “/” denotes element-wise division. The character ∪ denotes OR operation.

First of all, element-wise multiplication is performed on the feature map x (i.e., the first feature map) and the mask mₓ, obtaining a multiplication result being the second 3×3 matrix in the first row counting from the upper left corner in FIG. 3, i.e., the 3×3 matrix located above mₓ⊙x.

At the meantime, element-wise multiplication is performed on the feature map y (i.e., the second feature map) and the mask m_{y}, obtaining a multiplication result being second 3×3 matrix in the second row counting from the left in FIG. 3, i.e., the 3×3 matrix located above m_{y}⊙y.

Then, the two multiplication results are added, obtaining an addition result being the third 3×3 matrix in FIG. 3 in the first row counting from the upper left corner, i.e., the 3×3 matrix located above mₓ⊙x+m_{y}⊙y.

Next, element-wise multiplication is performed on the addition result mₓ⊙x+m_{y}⊙y and a reciprocal of a weight matrix, to form a feature map z having subjected to sparse addition, i.e., the 3×3 matrix located at the upper right corner. One example of the reciprocal of the weight matrix may be: 1/(mₓ+m_{y}+ε), where the ε is a constant far smaller than 1. For example, the value of ε may range within 0.00005-0.0001. The ε is mainly used to prevent the denominator from being 0. The result of mₓ+m_{y} is as illustrated by the 3×3 matrix at the right side of a third row in FIG. 3.

While sparse addition is performed on the feature map x and the feature map y, sparse addition may also be performed on the mask mₓ for the feature map x and the mask m_{y} for the feature map y. For example, OR operation is performed on the mask mₓ for the feature map x and the mask m_{y} for the feature map y, to form a mask m_{z} for the feature map z having subjected to sparse addition, i.e., the 3×3 matrix located at the lower right corner.

In the embodiments of the disclosure, the following formula (3) may be used to represent sparse addition on the feature maps, and the following formula (4) may be used to represent the sparse addition on the masks for the feature maps:

z=(mₓ⊙x+m_{y}⊙y)/(mₓ+m_{y}+ε) Formula (3)

m_{z}=mₓ∪m_{y} Formula (4)

In an optional example of the embodiments of the disclosure, the implementation process of sparse merging and convolution is as illustrated in FIG. 4.

In FIG. 4, the cuboid at the upper left corner denotes a feature map x. The cuboid located below the feature map x denotes a feature map y. The 3×3 matrix located below the feature map y denotes a mask mₓ for the feature map x. The 3×3 matrix located below the mask mₓ for the feature map x denotes a mask m_{y} for the feature map y. The character ⊙ denotes element-wise multiplication. The character ⊕ denotes element-wise addition. The character ⊗ denotes multiplication. The character/denotes element-wise division. cₓ denotes the number of channels of the feature map x, and c_{y} denotes the number of channels of the feature map y. The character * denotes convolution.

First of all, the feature map x (i.e., the first feature map) and the feature map y (i.e., the second feature map) are merged in a dimension of the number of channels, with a merged result as illustrated by the cuboid located above [xy] in FIG. 4. The merged result may be denoted as [xy], and the number of channels of [xy] is cₓ+c_{y}.

Then, convolution operation is performed on the merged result [xy], where kₓ denotes a size of a convolution kernel of the present convolution operation.

Next, element-wise multiplication is performed on the feature map having subjected to the convolution operation and a reciprocal of a weight matrix to form a feature map z having subjected to sparse merging and convolution.

While the sparse merging and convolution is performed on the feature map x and the feature map y, sparse merging and convolution may also be performed on the mask mₓ for the feature map x and the mask m_{y} for the feature map y. For example, the mask mₓ for the feature map x is multiplied by the number of channels cₓ of the feature map x, and the mask m_{y} for the feature map y is multiplied by the number of channels c_{y} of the feature map y. The two multiplication results are added, with an addition result as illustrated by the rightmost 3×3 matrix in the lower part of FIG. 4, i.e., the 3×3 matrix located above u=cₓmₓ+c_{y}m_{y} in FIG. 4. Convolution operation is performed on the addition processed result u=cₓmₓ+c_{y}m_{y}, where kₘ denotes the size of the convolution kernel of the present convolution operation. A weight matrix is formed according to a result of the convolution operation. One example of a reciprocal of the weight matrix may be: 1/(u*kₘ+ε), where ε is a constant far smaller than 1. For example, the value of ε may range within 0.00005-0.0001. The ε is mainly used to prevent the denominator from being 0. The weight matrix is binarized to form a mask m_{z} for the feature map z having subjected to sparse merging and convolution. One example of the binarization for the weight matrix u*kₘ in the embodiments of the disclosure may be represented as: (u*kₘ)/(u*kₘ+ε).

In the embodiments of the disclosure, the following formula (5) may be used to represent the sparse merging and convolution for the feature maps, and the following formula (6) may be used to represent the sparse merging and convolution for the masks for the feature maps:

z=([xy]*kₓ)/((cₓmₓ+c_{y}m_{y})*kₘ+ε) Formula (5)

m_{z}=((cₓmₓ+c_{y}m_{y})*kₘ)/((cₓmₓ+c_{y}m_{y})*kₘ+ε) Formula (6)

In an optional example of the embodiments of the disclosure, one example of the fusion module including two paths of inputs and outputs (i.e., a bi-scale fusion module) is illustrated in FIG. 5.

In FIG. 5, illustrated at the leftmost side are two paths of inputs. The two paths of inputs may be referred to as an upper path of input and a lower path of input. Two feature maps of respective different scales are provided to the fusion module through the two paths of inputs respectively. Correspondingly, masks for the two feature maps of the different scales are also provided to the fusion module through the two paths of inputs respectively. In FIG. 5, illustrated at the rightmost side are two paths of outputs, which may be referred to as an upper path of output and a lower path of output. The two feature maps of the different scales and the masks, formed after the fusion module performs valid point feature fusion for the two paths of inputs respectively, become the upper path of output and the lower path of output.

The fusion module downsamples (a leftmost box filled with vertical lines in the middle region of FIG. 5, the middle region in the embodiments of the disclosure refers to a region between the uppermost side and the lowest side in the drawing, which is the same in the following, and description will not be made each time) the upper path of input, such that a result of the downsampling has the same scale as the lower path of input (i.e., the result of the downsampling has the same size as the lower input, and it is to be noted that the size of the box in FIG. 5 does not represent the size of the scale). The fusion module performs sparse merging and convolution (a box filled with dots at the lower left corner in FIG. 5) on a result of the downsampling and the lower path of input. The fusion module performs sparse convolution (a box filled with leftward inclined lines at the lower right corner in FIG. 5, in which a leftward inclined line refers to a line inclining from the upper right side to the lower left side in the box) on a result of the sparse merging and convolution. A result of the present sparse convolution is a lower path of output for the fusion module. The fusion module may perform the above operations on both an input feature map and mask respectively, and the obtained feature map and mask both serve as the lower path of output.

The fusion module performs sparse convolution (a box filled with the left-toward inclined lines in the middle part of the upper region in FIG. 5) on the upper path of input. The fusion module further performs convolution (a box filled with rightward inclined lines in the middle part of the right region in FIG. 5, in which the rightward inclined line refers to a line inclining from the upper left side to the lower right side in the box) on the lower path of output. The convolution may include: convolution having a convolution kernel of 1×1. The fusion module performs sparse upsampling (a box filled with horizontal lines in the middle part of the right region in FIG. 5) on a convolution processed result, such that a result of the sparse upsampling has a same scale as a result of the sparse convolution for the upper path of input. The fusion module performs sparse addition (a box filled with diamonds at the upper right corner in FIG. 5) on a result of the sparse convolution for the upper path of input and a result of the sparse upsampling, and a result of the present sparse addition serves as an upper path of output for the fusion module. The fusion module may perform the above operations on both an input feature map and mask respectively, and the obtained feature map and mask both serve as the upper path of output.

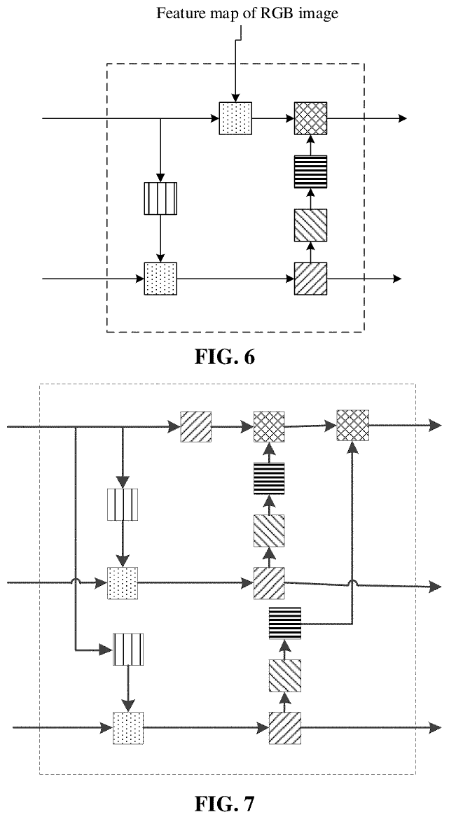

In an optional example of the embodiments of the disclosure, another example of the fusion module including two paths of inputs and outputs (i.e., a bi-scale fusion module) is illustrated in FIG. 6.

In FIG. 6, illustrated at the leftmost side are two paths of inputs. The two paths of inputs may be referred to as an upper path of input and a lower path of input. Two feature maps of respective different scales are provided to the fusion module through the two paths of inputs respectively. Correspondingly, masks for the two feature maps of the different scales are also provided to the fusion module through the two paths of inputs respectively. In FIG. 6, illustrated at the rightmost side are two paths of outputs, which may be referred to as an upper path of output and a lower path of output. The two feature maps of different scales and masks, formed after the fusion module performs valid point feature fusion for the two paths of inputs respectively with consideration of a feature map of an RGB image, become the upper path of output and the lower path of output.

The fusion module downsamples (a leftmost box filled with vertical lines in the middle region of FIG. 6) the upper path of input, such that a result of the downsampling has the same scale as the lower path of input. The fusion module performs sparse merging and convolution (a box filled with dots at the lower left corner in FIG. 6) on the result of the downsampling and the lower path of input. The fusion module performs sparse convolution (a box filled with leftward inclined lines at the lower right corner in FIG. 6, in which the leftward inclined line refers to a line inclining from the upper right side to the lower left side in the box) on a result of the sparse merging and convolution. A result of the present sparse convolution is the lower path of output for the fusion module. The fusion module may perform the above operations on both an input feature map and mask respectively, and the obtained feature map and mask both serve as the lower path of output.

The fusion module performs sparse merging and convolution (an uppermost box filled with dots in FIG. 6) on the upper path of input and the feature map of the RGB image. The fusion module further performs convolution (a box filled with rightward inclined lines in the middle part of the right region in FIG. 6, in which the rightward inclined line refers to a line inclining from the upper left side to the lower right side in the box) on the lower path of output. The convolution may include: convolution having a convolution kernel of 1×1. The fusion module performs sparse upsampling (a box filled with horizontal lines in the middle part of the right region in FIG. 6) on the result of the convolution, such that the result of the sparse upsampling has the same scale as the result of the sparse convolution of the upper path of input. The fusion module performs sparse addition (a box filled with diamonds at the upper right corner in FIG. 6) on the result of the sparse convolution for the upper path of input and the result of the sparse upsampling, and the result of the present sparse addition is the upper path of output for the fusion module. The fusion module may perform the above operations on both an input feature map and mask respectively, and the obtained feature map and mask both serve as the upper path of output.

In an optional example of the embodiments of the disclosure, one example of the fusion module including three paths of inputs and outputs (i.e., a three-scale fusion module) is illustrated in FIG. 7.

In FIG. 7, illustrated at the leftmost side are three paths of inputs, and the three paths of inputs may be referred to as an upper path of input, a middle path of input and a lower path of input respectively. Three feature maps of respective different scales are provided to the fusion module through the three paths of inputs. Correspondingly, masks for the three feature maps of the different scales are also provided to the fusion module through the three paths of inputs respectively. In FIG. 7, illustrated at the rightmost side are three paths of outputs, which may be referred to as an upper path of output, a middle path of output and a lower path of output respectively. The three feature maps of different scales and masks, formed after the fusion module performs valid point feature fusion for the three paths of inputs respectively, become the upper path of output, the middle path of output and the lower path of output.

The fusion module downsamples (an upper leftmost box filled with vertical lines in the middle region in FIG. 7) the upper path of input, such that a result of the downsampling has the same scale as the middle path of input. The fusion module performs sparse merging and convolution (a leftmost box filled with dots in the middle region in FIG. 7) on the result of the downsampling and the middle path of input. The fusion module performs sparse convolution (a rightmost box filled with leftward inclined lines in the middle region in FIG. 7) on a result of the present sparse merging and convolution. A result of the present sparse convolution is the middle path of output for the fusion module. The fusion module may perform the above operations on both an input feature map and mask respectively, and the obtained feature map and mask both serve as the middle path of output.

The fusion module performs downsampling (a lower leftmost box filled with vertical lines in the middle region in FIG. 7) on the upper path of input, such that a result of the downsampling has the same scale as the lower path of input. The fusion module performs sparse merging and convolution (a box filled with dots at the lower left corner in FIG. 7) on the result of the downsampling and the lower path of input. The fusion module performs sparse convolution (a box filled with leftward inclined lines at the lower right corner in FIG. 7) on a result of the present sparse merging and convolution. A result of the present sparse convolution is the lower path of output for the fusion module. The fusion module may perform the above operations on both an input feature map and mask respectively, and the obtained feature map and mask both serve as the lower path of output.

The fusion module performs sparse convolution (a leftmost box filled with the leftward inclined lines at the upper side in FIG. 7) on the upper path of input. The fusion module further performs convolution (an uppermost box filled with rightward inclined lines in the middle part of the right region in FIG. 7, in which the rightward inclined line refers to a line inclining from the upper left side to the lower right side in the box) on the middle path of output. The convolution may include: convolution having a convolution kernel of 1×1. The fusion module performs sparse upsampling (an uppermost box filled with horizontal lines in the middle part of the right region in FIG. 7 on a result of the convolution), such that the result of the sparse upsampling has the same scale as the result of the sparse convolution of the upper path of input. The fusion module performs sparse addition (a left box filled with diamonds at the uppermost side in FIG. 7), to obtain a first sparse addition result on the result of the sparse convolution on the upper path of input and the result of the present sparse upsampling.

The fusion module performs convolution (a lowest box filled with rightward inclined lines at the middle part of the right region in FIG. 7, in which the rightward inclined line refers to a line inclining from the upper left side to the lower right side in the box) on the lower path of output. The convolution may include: convolution having a convolution kernel of 1×1. The fusion module performs sparse upsampling (a lowest box filled with horizontal lines at the middle part of the right region in FIG. 7) on the result of the convolution, such that the result of the sparse upsampling has the same scale as the first sparse addition result. The fusion module performs sparse addition (a box filled with diamonds at the upper right corner in FIG. 7) on the first sparse addition result and the result of the present sparse upsampling, to obtain a second sparse addition result. The second sparse addition result serves as the upper path of output for the fusion module. The fusion module may perform the above operations on both an input feature map and mask respectively, and the obtained feature map and mask both serve as the upper path of output.

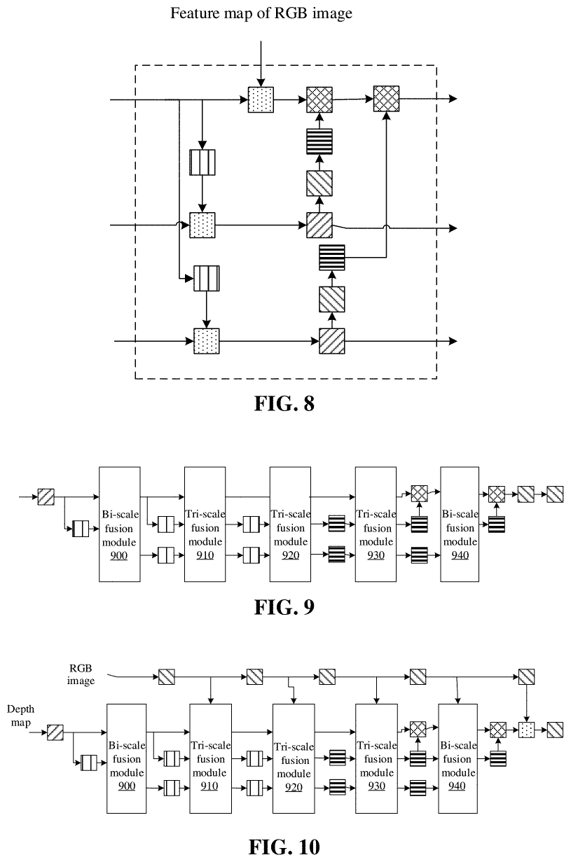

In an optional example of the embodiments of the disclosure, another example of the fusion module including three paths of inputs and outputs (i.e., a tri-scale fusion module) is illustrated in FIG. 8.

In FIG. 8, illustrated at the leftmost side are three paths of inputs, and the three paths of inputs may be referred to as an upper path of input, a middle path of input and a lower path of input respectively. Three feature maps of respective different scales are provided to the fusion module through the three paths of inputs. Correspondingly, masks for the three feature maps of the different scales are also provided to the fusion module through the three paths of inputs respectively. In FIG. 8, illustrated at the rightmost side are three paths of outputs, which may be referred to as an upper path of output, a middle path of output and a lower path of output respectively. The three feature maps of different scales and masks, formed after the fusion module performs valid point feature fusion on the three path of inputs respectively with consideration of a feature map of an RGB image, become the upper path of output, the middle path of output and the lower path of output.

The fusion module downsamples (an upper leftmost box filled with vertical lines in the middle region in FIG. 8) the upper path of input, such that a result of the downsampling has the same scale as the middle path of input. The fusion module performs sparse merging and convolution (a leftmost box filled with dots in the middle region in FIG. 8) on the result of the downsampling and the middle path of input. The fusion module performs sparse convolution (a rightmost box filled with leftward inclined lines in the middle region in FIG. 8) on a result of the present sparse merging and convolution. A result of the present sparse convolution is the middle path of output for the fusion module. The fusion module may perform the above operations on both an input feature map and mask respectively, and the obtained feature map and mask both serve as the middle path of output.

The fusion module downsamples (a lower leftmost box filled with vertical lines in the middle region in FIG. 8) the upper path of input, such that a result of the downsampling has the same scale as the lower path of input. The fusion module performs sparse merging and convolution (a box filled with dots at the lower left corner in FIG. 8) on the result of the downsampling and the lower path of input. The fusion module performs sparse convolution (a box filled with leftward inclined lines at the lower right corner in FIG. 8) on a result of the present sparse merging and convolution. A result of the present sparse convolution is the lower path of output for the fusion module. The fusion module may perform the above operations on both an input feature map and mask respectively, and the obtained feature map and mask both serve as the lower path of output.

The fusion module performs sparse merging and convolution (a leftmost box filled with dots at the upper side in FIG. 8) on the upper path of input and the feature map of the RGB image. The fusion module further performs convolution (an uppermost box filled with rightward inclined lines in the middle part of the right region in FIG. 8, in which the rightward inclined line refers to a line inclining from the upper left side to the lower right side in the box) on the middle path of output. The convolution may include: convolution having a convolution kernel being 1×1. The fusion module performs sparse upsampling (an uppermost box filled with horizontal lines in the middle part of the right region in FIG. 8) on a result of the convolution, such that the result of the sparse upsampling has the same scale as the result of the sparse merging and convolution for the upper path of input. The fusion module performs sparse addition (a left box filled with diamonds at the uppermost side in FIG. 8) on the result of the sparse merging and convolution for the upper path of input and the result of the present sparse upsampling, to obtain a first sparse addition result.

The fusion module performs convolution (a lowermost box filled with rightward inclined lines in the middle part of the right region in FIG. 8, in which the rightward inclined line refers to a line inclining from the upper left side to the lower right side in the box) on the lower path of output. The convolution may include: convolution having a convolution kernel of 1×1. The fusion module performs sparse upsampling (a lowermost box filled with horizontal lines in the middle part of the right region in FIG. 8 on the result of the convolution), such that a result of the sparse upsampling has the same scale as the first sparse addition result. The fusion module performs sparse addition (a box filled with diamonds at the upper right corner in FIG. 8) on the first sparse addition result and the result of the present sparse upsampling, to obtain a second sparse addition result. The second sparse addition result serves as the upper path of output for the fusion module. The fusion module may perform the above operations on both an input feature map and mask respectively, and the obtained feature map and mask both serve as the upper path of output.

In an optional example of the embodiments of the disclosure, one example of a neural network including multiple fusion modules is illustrated in FIG. 9.

In FIG. 9, the neural network includes: a first input processing unit, two bi-scale fusion modules (i.e., bi-scale fusion modules 900 and 940 in FIG. 9), three tri-scale fusion modules (i.e., tri-scale fusion modules 910, 920 and 930 in FIG. 9), five first conversion modules, two second conversion modules and a first output processing unit.

The first input processing unit includes a box filled with leftward inclined lines at the leftmost side of FIG. 9 and a box filled with vertical lines at the leftmost side.

The first one of the first conversion modules is provided between the bi-scale fusion module 900 and the tri-scale fusion module 910 in FIG. 9, and the first one of the first conversion modules includes: two boxes filled with vertical lines. The first one of the first conversion modules is mainly configured to perform scale conversion (such as downsampling) on feature maps output by an upper and lower paths of the bi-scale fusion module 900 respectively, and the feature maps having subjected to the scale conversion respectively serve as a middle path of input and a lower path of input for the tri-scale fusion module 910. The upper path of output of the bi-scale fusion module 900 is directly provided as an upper path of input for the tri-scale fusion module 910. The first one of the first conversion modules may further perform scale conversion (such as downsampling) on masks output by the upper and lower paths of the bi-scale fusion module 900, and the scale conversion processed masks also serve as the middle path of input and the lower path of input for the tri-scale fusion module 910.

The second one of the first conversion modules is provided between the tri-scale fusion module 910 and the tri-scale fusion module 920 in FIG. 9, and the second one of the first conversion modules includes: two boxes filled with vertical lines. The second one of the first conversion modules is mainly configured to perform scale conversion (such as downsampling) on feature maps output by the middle and lower paths of the tri-scale fusion module 910 respectively, and the feature maps having subjected to the scale conversion serve as a middle path of input and a lower path of input for the tri-scale fusion module 920. The upper path of output for the tri-scale fusion module 910 is directly provided as an upper path of input for the tri-scale fusion module 920. The second one of the first conversion modules may further perform scale conversion (such as downsampling) on masks output by the middle and lower paths of the tri-scale fusion module 910, and the scale conversion processed masks also serve as the middle path of input and the lower path of input for the tri-scale fusion module 920.

The third one of the first conversion modules is provided between the tri-scale fusion module 920 and the tri-scale fusion module 930 in FIG. 9, and the third one of the first conversion modules includes: two boxes filled with horizontal lines. The third one of the first conversion modules is mainly configured to perform scale conversion (such as sparse upsampling) on feature maps output by middle and lower paths of the tri-scale fusion module 920, and the feature maps having subjected to the scale conversion serve as a middle path of input and a lower path of input for the tri-scale fusion module 930. The upper path of output of the tri-scale fusion module 920 is directly provided as an upper path of input for the tri-scale fusion module 930. The third one of the first conversion modules may further perform scale conversion (such as sparse upsampling) on masks output by the middle and lower paths of the tri-scale fusion module 920, and the scale conversion processed masks also serve as the middle path of input and the lower path of input for the tri-scale fusion module 930.

The fourth one of the first conversion modules is provided between the tri-scale fusion module 930 and the bi-scale fusion module 940 in FIG. 9, and the fourth one of the first conversion modules includes: two boxes filled with horizontal lines. The fourth one of the first conversion modules is mainly configured to perform scale conversion (such as sparse upsampling) on feature maps output by middle and lower paths of the tri-scale fusion module 930, and the feature map having subjected to the scale conversion output by the lower path of the tri-scale fusion module 930 serves as a lower path of input for the bi-scale fusion module 940. The fourth one of the first conversion modules may further perform scale conversion (such as sparse upsampling) on masks output by the middle and lower paths of the tri-scale fusion module 930, and the scale conversion processed mask in the lower path of the tri-scale fusion module 930 also serves as the lower path of input for the bi-scale fusion module 940.

The fifth one of the first conversion modules is provided immediately after the bi-scale fusion module 940 in FIG. 9, and the fifth one of the first conversion modules includes: a boxes filled with horizontal lines. The fifth one of the first conversion modules is mainly configured to perform scale conversion (such as sparse upsampling) on a feature map output by a lower path of the bi-scale fusion module 940.

The first one of the second conversion modules is provided between the tri-scale fusion module 930 and the bi-scale fusion module 940 in FIG. 9, and the first one of the second conversion modules includes: a box filled with diamonds. The first one of the second conversion module is mainly configured to perform sparse addition for an upper path of output of the tri-scale fusion module 930 and a result of the fourth one of the first conversion modules performs scale conversion for the middle path of output of the tri-scale fusion module 930. A result of the sparse addition serves as an upper path of input for the bi-scale fusion module 940.

The second one of the second conversion module is provided immediately after the bi-scale fusion module 940 in FIG. 9, and the second one of the second conversion modules includes: a box filled with diamonds. The second one of the second conversion modules is mainly configured to perform sparse addition on the upper path of output of the bi-scale fusion module 940 and the output of the fifth one of the first conversion modules. A result of the sparse addition is provided to the first output processing unit.

The first output processing unit is provided at the rightmost side in FIG. 9, and includes: two boxes filled with rightward inclined lines. The first output processing unit is mainly configured to perform convolution on an input feature map and mask twice. A convolution kernel used in the first time of convolution may be 3×3, and a convolution kernel used in the second time of convolution may be 1×1. A processed depth map is output finally.

In an optional example of the embodiments of the disclosure, another example of a neural network including multiple fusion modules is illustrated in FIG. 10.

In FIG. 10, the neural network includes: a second input processing unit, two bi-scale fusion modules (i.e., bi-scale fusion modules 900 and 940 in FIG. 10), three tri-scale fusion modules (i.e., tri-scale fusion modules 910, 920 and 930 in FIG. 10), five first conversion modules, two second conversion modules and a first output processing unit.

Besides the box filled with left-toward inclined lines at the leftmost side and the box filled with vertical lines at the leftmost side in FIG. 10, the second input processing unit further includes five boxes filled with rightward inclined lines at the uppermost side in FIG. 10, for performing convolution on RGB images to form feature maps of corresponding scales. Reference can be made to the description of FIG. 9 with regard to the two bi-scale fusion modules, the three tri-scale fusion modules, the five first conversion modules and the two second conversion modules. Detailed description will not be made here.

The second output processing unit is provided at the rightmost side in FIG. 10, and includes: a box filled with the dots and a box filled with the rightward inclined lines. The second output processing unit is mainly configured to first perform sparse merging and convolution on feature maps and masks on two paths of inputs respectively, then perform convolution and output a processed depth map finally.

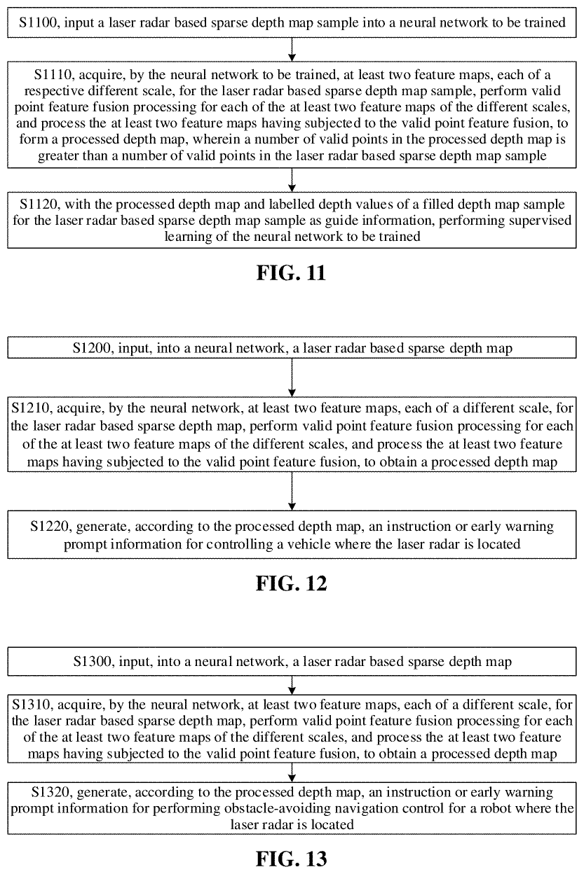

The neural network in the embodiments of the disclosure is obtained by training based on laser radar based sparse depth map samples and labelled values of filled depth map samples for the laser radar based sparse depth map samples. In an optional example of the embodiments of the disclosure, a flowchart of an implementation of a method for training a neural network is illustrated in FIG. 11. As illustrated in FIG. 11, the method of the embodiments includes the following operations.

In S1100, a laser radar based sparse depth map sample is input into a neural network to be trained.

In an optional example, the laser radar based sparse depth map sample may be acquired from a training data set in the embodiments of the disclosure. In the embodiments of the disclosure, the training data set includes multiple laser radar based sparse depth map samples for training the neural network. Generally, each laser radar based sparse depth map sample is provided with labelled depth values for multiple points. In the embodiments of the disclosure, one or more laser radar based sparse depth map samples are read once from the training data set in a random reading manner or in a manner of sequentially reading according an arrangement order of image samples

In an optional example, the operation S1100 may be executed by a processor by calling corresponding instructions stored in a memory, and may also be executed by a depth map sample input module 1700 operated by the processor.

In S1110, the neural network to be trained acquires at least two feature maps, each of a respective different scale, from the laser radar based sparse depth map sample, performs valid point feature fusion on each of the at least two feature maps of the different scales, and forms a processed depth map according to a result of the valid point feature fusion. The number of valid points in the processed depth map is greater than the number of valid points in the laser radar based sparse depth map sample. The specific implementation process of the operation may refer to the relevant description of the above implementations, and will not be described here again.

In an optional example, the operation S1110 may be executed by the processor by calling corresponding instructions stored in a memory, and may also be executed by the neural network 1710 to be trained operated by the processor.

In S1120, with the processed depth map as well as labelled depth values of the filled depth map sample for the laser radar based sparse depth map sample as guide information, supervised learning of the neural network to be trained is realized.

In an optional example, the operation S1120 may be executed by the processor by calling corresponding instructions stored in a memory, and may also be executed by a supervision module 1720 operated by the processor.

In an optional example, the guide information in the embodiments of the disclosure generally includes: a difference between a depth value of each point in the depth map output by the neural network to be trained, and the labelled depth value of the filled depth map sample for the laser radar based sparse depth map sample. In the embodiments of the disclosure, supervised learning of the neural network to be trained may be implemented using a corresponding function, for the purpose of reducing the difference.

In an optional example of the embodiments of the disclosure, the loss function indicated in the following formula (7) may be used:

$$L ( x , y ) = \frac{1}{\vert V \vert} {\sum }_{( i , j ) ∈ V} {\vert {x}_{ij} - {y}_{ij} \vert}^{2} \qquad Formula ( 7 )$$

In the formula (7), V denotes a set of coordinates, in the depth map, of processed labelled depth values of valid points. It may also be considered that the character V is a set of coordinates of valid points in a ground truth depth map. The ground truth depth map may be considered as a laser radar based dense depth map sample, i.e., a filled depth map sample for the laser radar based sparse depth map sample. |V| denotes the number of valid points in the laser radar based dense depth map sample. The expression xᵢⱼ denotes a predicted depth value at a position (i, j) in the processed depth map output by the neural network to be trained; and the expression yᵢⱼ denotes a labelled depth value at a position (i, j) in the laser radar based dense depth map sample.

In an optional example, when the training for the neural network to be trained reaches a predetermined iteration condition, the present training process is ended. The predetermined iteration condition in the embodiments of the disclosure may include: the difference between the depth value in the depth map output by the neural network to be trained and the labelled depth value in the filled depth map sample for the laser radar based sparse depth map sample meets a predetermined difference requirement. In the case where the difference meets the predetermined difference requirement, the present training for the neural network is completed successfully. In the embodiments of the disclosure, the predetermined iteration condition may also include: the number of samples used in training the neural network to be trained reaches a predetermined number requirement, etc. In the case where the number of used samples reaches the predetermined number requirement but the difference does not meet the predetermined difference requirement, the present training for the neural network is not successfully. The successfully trained neural network may be used to process a depth map.

FIG. 12 illustrates a flowchart of an implementation of a method for intelligently controlling a vehicle according to an embodiment of the disclosure. As illustrated in FIG. 12, the method of the embodiments includes the following operations.

In S1200, a laser radar based sparse depth map is input into a neural network. Optionally, RGB images photographed by a photographic device and having the same or basically same angle of view and a same size as the laser radar based sparse depth map may also be provided to the neural network.

In an optional example, operation S1200 may be executed by a processor by calling corresponding instructions stored in a memory, and may also be executed by a depth map input module 1400 operated by the processor.

In S1210, the neural network acquires at least two feature maps, each of a respective different scale, for the laser radar based sparse depth map, performs valid point feature fusion for each of the at least two feature maps of the different scales, and obtains a processed depth map according to a result of the valid point feature fusion.

In an optional example, operation S1210 may be executed by the processor by calling corresponding instructions stored in a memory, and may also be executed by the neural network 1410 operated by the processor.

The implementation processes of the operation S1200 and the operation S1210 may refer to the relevant descriptions on the above implementations, and will not be described here again.

In S1220, an instruction or early warning prompt information for controlling a vehicle where a laser radar is located is generated according to the processed depth map. The generated instruction is for example an instruction for accelerating a speed, an instruction for lowering the speed or an emergency brake instruction, etc. The generated early warning prompt information is prompt information of paying attention to a pedestrian at some orientation, etc. The implementation of generating the instruction or the early warning prompt information according to the processed depth map is not limited in the embodiments of the disclosure.

In an optional example, the operation S1220 may be executed by the processor by calling corresponding instructions stored in a memory, and may also be executed by a control module 1420 operated by the processor.

FIG. 13 illustrates a flowchart of an implementation of a method for obstacle-avoiding navigation according to an embodiment of the disclosure. As illustrated in FIG. 13, the method of the embodiment includes the following operations.

In S1300, a laser radar based sparse depth map is input into a neural network. Optionally, RGB images photographed by a photographic device and having the same or basically same angle of view and a same size as the laser radar based sparse depth map may also be provided to the neural network.

In an optional example, the operation S1300 may be executed by a processor by calling a corresponding instruction stored in a memory, and may also be executed by a depth map input module 1400 operated by the processor.

In S1310, the neural network acquires at least two feature maps, each of a respective different scale, for the laser radar based sparse depth map, performs valid point feature fusion for each of the at least two feature maps of the different scales, and obtains a processed depth map according to a result of the valid point feature fusion. The number of valid points in the processed depth map is greater than the number of valid points in the laser radar based sparse depth map sample.

In an optional example, operation S1310 may be executed by the processor by calling corresponding instructions stored in a memory, and may also be executed by the neural network 1410 operated by the processor.

The implementation processes of the operation S1300 and the operation S1310 may refer to the relevant description on the above implementations, and will not be described here again.

In S1320, an instruction or early warning prompt information for performing obstacle avoidance control for a robot where a laser radar is located is generated according to the processed depth map. The generated instruction is for example an instruction for lowering an action speed, an instruction for suspending an action or a turning instruction, etc. The generated early warning prompt information is prompt information of paying attention to an obstacle at some orientation, etc. The implementation of generating the instruction or the early warning prompt information according to the processed depth map is not limited in the embodiments of the disclosure.

In an optional example, operation S1320 may be executed by the processor by calling a corresponding instruction stored in a memory, and may also be executed by an obstacle avoidance navigation module 1430 operated by the processor.

Any method provided in the embodiments of the disclosure may be executed by any suitable device having a data processing capability, including but not limited to: a terminal device, a server, etc. Alternatively, any method provided in the embodiments of the disclosure may be executed by a processor. For example, the processor executes any method mentioned in the embodiments of the disclosure by calling a instructions stored in the memory. Description will not be made hereinafter.

Those of ordinary skill in the art should know that all or part of the operations of the method embodiment may be implemented by related hardware instructed through a program, the program may be stored in a computer-readable storage medium. The program, when executed, performs operations of the method embodiment. The storage medium includes various media capable of storing program codes such as a Read-Only Memory (ROM), a Random Access Memory (RAM), a magnetic disk or a compact disc.

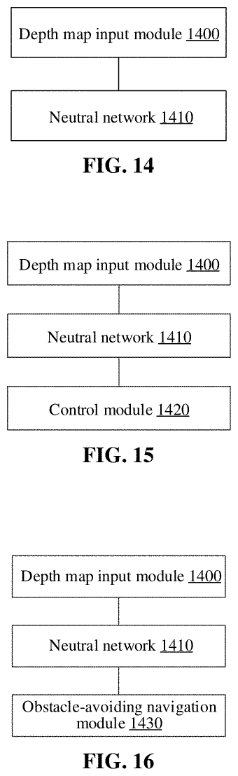

FIG. 14 illustrates a schematic structural diagram of an implementation of an apparatus for processing a laser radar based sparse depth map according to an embodiment of the disclosure. As illustrated in FIG. 14, the apparatus of the embodiment mainly includes: a depth map input module 1400 and a neural network 1410.

The depth map input module 1400 is configured to input a laser radar based sparse depth map to the neural network 1410.

In an optional example, the depth map input module 1400 is configured to: input, into the neural network 1410, a laser radar based sparse depth map and a mask for the laser radar based sparse depth map. The mask for the laser radar based sparse depth map is configured to indicate valid points in the laser radar based sparse depth map.

The neural network 1410 is configured to acquire at least two feature maps, each of a respective different scale, for the laser radar based sparse depth map, perform valid point feature fusion for each of the at least two feature maps of the different scales, and obtain a processed depth map according to a result of the valid point feature fusion. A number of valid points in the processed depth map is greater than a number of valid points in the laser radar based sparse depth map.

In an optional example, the neural network 1410 is further configured to determine, according to the mask for the laser radar based sparse depth map, a mask for each of the at least two feature maps of the different scales. In such a case, the valid point feature fusion operation performed by the neural network 1410 for each of the at least two feature maps of the different scales may include that: valid point feature fusion is performed for each of the at least two feature maps of the different scales according to the masks for the at least two feature maps of the different scales.

In an optional example, the neural network 1410 may include: an input processing unit. The input processing unit is configured to perform sparse convolution on the laser radar based sparse depth map to obtain a feature map for the laser radar based sparse depth map, and perform scale conversion on the feature map of the depth map to obtain the at least two feature maps of the different scales. The at least two feature maps of the different scales include the feature map having not subjected to the scale conversion, and at least one feature map having subjected to the scale conversion.

In an optional example, the input processing unit is further configured to perform sparse convolution on the mask for the laser radar based sparse depth map to obtain a mask for the feature map of the laser radar based sparse depth map, and perform scale conversion on the mask for the feature map, to obtain a mask of each of the at least two feature maps.

In an optional example, the neural network 1410 may include: at least one fusion module. The at least one fusion module includes multiple paths of inputs and outputs. The fusion module is configured to perform valid point feature fusion for the feature maps of the different scales in the multiple paths of inputs. In the case where the neural network 1410 includes multiple fusion modules, an output from a level of fusion module is provided as an input for another level of fusion module immediately following the level of fusion module.

In an optional example, the neural network further includes: at least one first conversion module. The at least one first conversion module is provided immediately after a respective one of the at least one fusion module. That is to say, a path of output from a fusion module is provided to a respective first conversion module. The first conversion module is configured to perform scale conversion on a feature map in at least one path of output from a level of fusion module. The feature map having subjected to the scale conversion is provided to another level of fusion module immediately following the level of fusion module. That is, the output from the first conversion module is provided to the another level of fusion module.

In an optional example, in the case where the number of paths of outputs from a level of fusion module is smaller than the number of paths of inputs for another level of fusion module immediately following the level of fusion module, one of the paths of outputs from the level of fusion module and a feature map in the path of output after subjecting to scale conversion both serve as inputs for the another level of fusion module.

In an optional example, the neural network 1410 further includes: at least one second conversion module. Each of the at least one second conversion module is provided after a respective one of the at least one fusion module. The second conversion module is configured to perform valid point feature fusion on feature maps in at least two paths of outputs from the fusion module, to form one feature map. The feature map formed by the second conversion module may serve as an input for the another level of fusion module, and the feature map formed by the second conversion module may also serve as an input for an output processing unit of the neural network.

In an optional example, the depth map input module 1400 may be further configured to provide, to the neural network 1410, an image having the same angle of view and a same size as the laser radar based sparse depth map. The image includes: an image photographed by a photographic device. In such an application scenario, the input processing unit may further be configured to acquire at least one feature map of a respective scale for the image, and the feature image of the corresponding scale for the image serves as an input for the corresponding fusion. The feature map for the image is to be fused with the feature map of the laser radar based sparse depth map.

In an optional example, in the case where the fusion module includes N paths of inputs and outputs, valid point feature fusion executed on an M^{th} path of input by the fusion module may include that: downsampling is performed on a feature map and a mask for the feature map in an N^{th} path of input; sparse merging and convolution is performed the downsampled feature map and mask, and a feature map and mask in an M^{th} path of input; and sparse convolution is performed on the feature map and mask having subjected to sparse merging and convolution, to obtain a feature map and mask having subjected to valid point feature fusion for an M^{th} path of output. The scale of the feature map in the N^{th} path of input is greater than that of the feature map in the M^{th} path of input. M an integer greater than 0, and N is an integer greater than M.

In an optional example, in the case where a fusion module includes N paths of inputs and outputs, valid point feature fusion executed on an N^{th} path of input by the neural network may include that: sparse convolution is performed on a feature map and mask in an N^{th} path of input; convolution is performed on a feature map and mask having subjected to valid point feature fusion in at least an M^{th} path of output; after that, sparse upsampling is performed on the feature map and mask having subjected to the convolution; and then, sparse addition is performed on the feature map and mask having subjected to sparse convolution in the N^{th} path, and the feature map and mask having subjected to sparse upsampling in at least the M^{th} path, to obtain a feature map and mask having subjected to valid point feature fusion for an N^{th} path of output.

In an optional example, the output processing unit may include a first output processing unit. The first output processing unit is configured to perform sparse addition on feature maps and masks having subjected to valid point feature fusion output by a final level of valid point feature fusion, and perform convolution on a sparse addition result to form a processed depth map.

In an optional example, in the case where the at least one fusion module includes N paths of inputs and outputs, valid point feature fusion executed on an N^{th} path of input by the fusion module may include that: sparse merging and convolution is performed on a feature map and mask in the N^{th} path of input and the feature map of the image; convolution is performed on a feature map and mask having subjected to valid point feature fusion in at least an M^{th} path of output; after that, sparse upsampling is performed on the feature map and mask having subjected to the convolution; and then, sparse addition is performed on the feature map and mask having subjected to the sparse merging and convolution in the N^{th} path, and the feature map and mask having subjected to sparse upsampling in at least the M^{th} path, to form a feature map and mask having subjected to valid point feature fusion for an N^{th} path of output. M is an integer greater than 0, and N is an integer greater than M.

In an optional example, the output processing unit may include a second output processing unit. The second output processing unit is configured to perform sparse addition on feature maps and masks having subjected to valid point feature fusion output by a final level of valid point feature fusion; perform sparse merging and convolution on a result of the sparse addition and the feature map of the image; and perform convolution on a result of the sparse merging and convolution, to form a processed depth map.

In an optional example, the sparse merging and convolution in the embodiments of the disclosure may include: merging a first feature map and a second feature map in a channel dimension, performing convolution on the merged feature map, and performing element-wise multiplication on the feature map having subjected to the convolution and a reciprocal of a weight matrix to form a feature map having subjected to sparse merging and convolution; and acquiring a first product of a mask for the first feature map and a number of channels of the first feature map, acquiring a second product of a mask for the second feature map and a number of channels of the second feature map, performing convolution operation on a sum of the first and second products, forming the weight matrix according to a result of the convolution operation, and binarizing the weight matrix to form a mask for the feature map having subjected to the sparse merging and convolution.

In an optional example, the sparse addition in the embodiments of the disclosure may include: performing element-wise multiplication on a first feature map and a mask for the first feature map, performing element-wise multiplication on a second feature map and a mask for the second feature map, adding two results of the multiplication, and performing element-wise multiplication on an addition result and a reciprocal of a weight matrix to form a feature map having subjected to sparse addition; and performing OR operation on the mask for the first feature map and the mask for the second feature map, to form a mask for the feature map having subjected to the sparse addition.

In an optional example, the sparse upsampling in the embodiments of the disclosure may include: performing element-wise multiplication on a feature map and a mask for the feature map, and upsampling a multiplication result; upsampling the mask for the feature map, and forming a weight matrix based on the upsampled mask; performing element-wise multiplication on the upsampled feature map and a reciprocal of the weight matrix, to form a feature map having subjected to sparse addition; and binarizing the weight matrix to form a mask for the feature map having subjected to sparse addition.

In an optional example, the neural network in the embodiments of the disclosure is obtained by training based on a laser radar based sparse depth map sample and labelled depth values of a filled depth map sample for the laser radar based sparse depth map sample.

Operations executed by the depth map input module 1400 and the neural network 1410 in the embodiments of the disclosure may be referred to relevant description in the implementations of the above methods. Description will not be made here again.

FIG. 15 illustrates a schematic structural diagram of an implementation of an apparatus for intelligently controlling a vehicle according to an embodiment of the disclosure. As illustrated in FIG. 15, the apparatus of the embodiment mainly includes: a depth map input module 1400, a neural network 1410 and a control module 1420.

The depth map input module 1400 is configured to input a laser radar based sparse depth map into the neural network.

The neural network 1410 is configured to acquire at least two feature maps, each of a respective different scale, for the laser radar based sparse depth map, perform valid point feature fusion for each of the at least two feature maps of the different scales, and obtain a processed depth map according to a result of the valid point feature fusion. The number of valid points in the processed depth map is greater than the number of valid points in the laser radar based sparse depth map in the embodiments of the disclosure.

The control module 1420 is configured to generate, according to the processed depth map output by the neural network 1410, an instruction or early warning prompt information for controlling a vehicle where a laser radar is located.

Operations executed by the depth map input module 1400, the neural network 1410 and the control module 1420 in the embodiments of the disclosure may be referred to relevant description in the implementations of the above methods. Description will not be made here again.

FIG. 16 illustrates a schematic structural diagram of an implementation of an apparatus for obstacle-avoiding navigation according to an embodiment of the disclosure. As illustrated in FIG. 16, the apparatus of the embodiment mainly includes: a depth map input module 1400, a neural network 1410 and an obstacle-avoiding navigation module 1430.

The depth map input module 1400 is configured to input a laser radar based sparse depth map into the neural network.

The neural network 1410 is configured to acquire at least two feature maps, each of a respective different scale, for the laser radar based sparse depth map, perform valid point feature fusion for each of the at least two feature maps of the different scales, and obtain a processed depth map according to a result of the valid point feature fusion. The number of valid points in the processed depth map is greater than the number of valid points in the laser radar based sparse depth map in the embodiments of the disclosure.

The obstacle-avoiding navigation module 1430 is configured to generate, according to the processed depth map output by the neural network 1410, an instruction or early warning prompt information for controlling obstacle-avoiding navigation for a robot where a laser radar is located.

Operations executed by the depth map input module 1400, the neural network 1410 and obstacle-avoiding navigation module 1430 in the embodiments of the disclosure may refer to relevant description in the implementations of the above methods. Description will not be made here again.

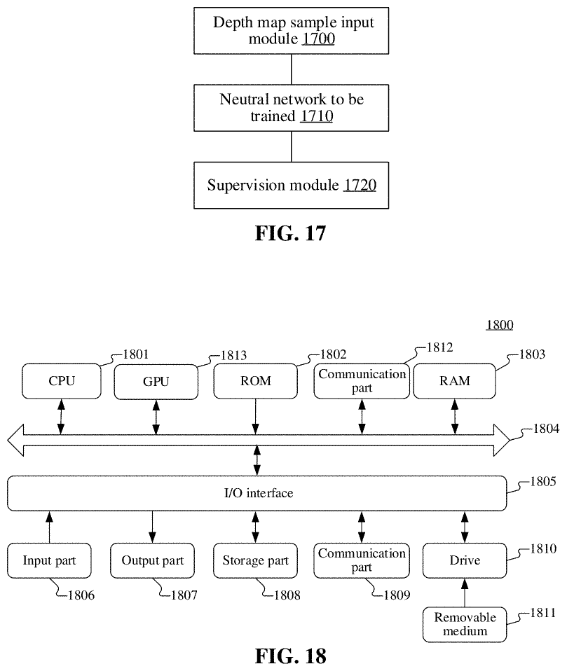

FIG. 17 illustrates a schematic structural diagram of an implementation of an apparatus for training a neural network according to an embodiment of the disclosure. As illustrated in FIG. 17, the apparatus of the embodiment mainly includes: a depth map sample input module 1700, a neural network to be trained 1710 and a supervision module 1720.

The depth map sample input module 1700 is configured to input a laser radar based sparse depth map sample into the neural network to be trained 1710.

The neural network 1710 to be trained is configured to acquire at least two feature maps, each of a respective different scale, for the laser radar based sparse depth map sample, perform valid point feature fusion on the at least two feature maps of the different scales, and then obtain a processed depth map according to a result of the valid point feature fusion. In the embodiments of the disclosure, the number of valid points in the processed depth map is greater than the number of valid points in the laser radar based sparse depth map sample.

The supervision module 1720 is configured to perform, with the processed depth map and labelled depth values of a filled depth map sample for the laser radar based sparse depth map sample as guide information, supervised learning of the neural network to be trained.

Operations executed by the depth map sample input module 1700, the neural network 1710 and the supervision module 1720 in the embodiments of the disclosure may refer to relevant description in the implementations of the above methods. Description will not be made here again.

Based on the method and apparatus for processing a laser radar based sparse depth map, the method and apparatus for training a neural network training, the method and apparatus for intelligently controlling a vehicle, the method and apparatus for obstacle-avoiding navigation, the electronic device, the computer-readable storage medium and the computer program provided in the embodiments of the disclosure, in embodiments of the disclosure, a neural network is used to perform valid point feature fusion for each of the at least two feature maps of the different scales for the laser radar based sparse depth map, such that the neural network may implement feature fusion for multiple branches. Feature maps may be formed in the different branches during the sparse depth map processing on the basis of considering the feature maps with different reception fields. Since global feature information may be obtained easier based on feature maps of different reception fields, more accurate information of edges of objects may be obtained through the valid point feature fusion in the embodiments of the disclosure. Thus, the accuracy of feature maps having subjected to fusion can be improved, and the phenomenon of depth breakage of an object in an image can be avoided. Moreover, by means of the valid point feature fusion, influence on feature fusion by invalid points in the feature map may be avoided, so that the accuracy of the feature map having subjected to fusion may be improved. Since more accurate feature maps are used to form a processed depth map in the embodiments of the disclosure, the processed laser radar depth map may be more precise.

It may be seen from the above description that the technical solutions provided in the embodiments of the disclosure enable a processed laser radar depth map to be more precise. Thus, the accuracy of decision making or early warning for intelligent driving and obstacle-avoiding guidance for robots can be improved when the technique for processing laser radar based sparse depth map according to the embodiments of the disclosure are applied to real-time environments for intelligent driving, such as automatic driving or aided driving, and obstacle-avoiding guidance for robots.

Exemplary Device

FIG. 18 illustrates an exemplary device 1800 suitable for implementing an embodiment of the disclosure. The device 1800 may be a control system/electronic system configured in a vehicle, a mobile terminal (for example, a smart mobile phone), a Personal Computer (PC) (for example, a desktop or a notebook), a tablet and a server, etc.

In FIG. 18, the device 1800 includes one or more processors, a communication component and the like. The one or more processors may be one or more Central Processing Units (CPUs) 1801 and/or one or more Graphics Processing Units (GPUs) 1813 configured to process a laser radar based sparse depth map by use of a neural network, etc. The processor may execute various proper actions and processing according to executable instructions stored in a ROM 1802 or executable instructions loaded from a storage 1808 to a RAM 1803. The communication component 1812 may include, but not limited to, a network card, and the network card may include, but not limited to, an InfiniBand (IB) network card. The processor may communicate with the ROM 1802 and/or the RAM 1803 to execute the executable instructions, is connected with the communication component 1812 through a bus 1804 and communicates with another target device through the communication component 1812, thereby completing the corresponding operations provided in any embodiment of the disclosure.

The operations executed by the above instructions may refer to the related description in the method embodiment and will not be described herein in detail. In addition, various programs and data required by the operations of the apparatus may further be stored in the RAM 1803. The CPU 1801, the ROM 1802 and the RAM 1803 are connected with one another through a bus 1804.

With existence of the RAM 1803, the ROM 1802 is an optional module. The RAM 1803 stores executable instructions, or the executable instructions are written in the ROM 1802 during operation. The executable instructions enable the CPU 1801 to execute the corresponding operations of the method for processing a laser radar based sparse depth map. An Input/Output (I/O) interface 1805 is also connected to the bus 1804. The communication unit 1812 may be arranged in an integrated manner, and may also be arranged to include multiple submodules (for example, multiple IB network cards) connected with the bus respectively.

The following components are connected to the I/O interface 1805: an input part 1806 including a keyboard, a mouse or the like; an output part 1807 including a Cathode-Ray Tube (CRT), a Liquid Crystal Display (LCD), a speaker or the like; the storage 1808 including a hard disk and the like; and a communication part 1809 including a Local Area Network (LAN) card, a network interface card of a modem or the like. The communication part 1809 executes communication processing through a network such as the Internet. A driver 1810 is also connected to the I/O interface 1805 as required. A removable medium 1811, for example, a magnetic disk, an optical disk, a magneto-optical disk and a semiconductor memory, is installed on the driver 1810 as required such that a computer program read therefrom is installed in the storage 1808 as required.

It is to be particularly noted that the architecture shown in FIG. 18 is only an optional implementation. The number and types of the components in FIG. 18 may be selected, deleted, added or replaced according to a practical requirement in practice. In terms of arrangement of different functional components, separate arrangement, integrated arrangement or the like may also be implemented. For example, the GPU and the CPU may be separately arranged. For another example, the GPU may be integrated to the CPU. The communication unit may be separately arranged and may also be integrated to the CPU or the GPU. All these alternative implementations shall fall within the scope of protection of the embodiments of the disclosure.

Particularly, according to the implementations of the disclosure, the process described below with reference to a flowchart may be implemented as a computer software program. For example, a computer program product according to the embodiments of the disclosure includes a computer program physically included in a machine-readable medium. The computer program includes program codes configured to execute the operations shown in the flowchart, and the program codes may include instructions corresponding to the operations the method provided in any embodiment of the disclosure.

In thus implementation, the computer program may be downloaded and installed from the Internet through the communication part 1809 and/or installed from the removable medium 1811. The computer program, when executed by the CPU 1801, performs the instructions for implementing the corresponding operations in any embodiment of the disclosure.

In one or more optional implementations, also provided in the embodiments of the disclosure is a computer program product configured to store computer-readable instructions which, when being executed, enable a computer to execute the method for processing a laser radar based sparse depth map, or the method for training a neural network, the method for intelligently controlling a vehicle, or a method for obstacle-avoiding navigation in any abovementioned embodiment.

The computer program product may specifically be implemented through hardware, software or a combination thereof. In an optional example, the computer program product is specifically embodied as a computer storage medium. In another optional example, the computer program product is specifically embodied as a software product, for example, a Software Development Kit (SDK).

In one or more optional implementations, also provided in the embodiments of the disclosure is another method for processing a laser radar based sparse depth map, method for training a neural network, method for intelligently controlling a vehicle, method for obstacle-avoiding navigation as well as corresponding apparatuses, an electronic device, a computer storage medium, a computer program and a computer program product. The methods include that: a first device sends, to a second device, an instruction for processing a laser radar based sparse depth map, or a neural network training instruction, or an instruction for intelligent control of a vehicle, or an instruction for obstacle-avoiding navigation. The instruction enables the second device to execute the method for processing a laser radar based sparse depth map, or the method for training a neural network, or the method for intelligently controlling a vehicle, or the method for obstacle-avoiding navigation in any abovementioned possible embodiment. The first device receives, from the second device, a processing result of the laser radar based sparse depth map, or a neural network training result, or a vehicle intelligent control result, or an obstacle-avoiding navigation result.

In some embodiments, the instruction of processing the laser radar based sparse depth map, or the instruction for training a neural network, or the instruction for intelligently controlling a vehicle, or the instruction for obstacle-avoiding navigation may include a calling instruction. The first device may instruct, by calling, the second device to execute an operation of processing a laser radar based sparse depth map, or a neural network training operation, or a vehicle intelligent control operation, or an obstacle-avoiding navigation operation. The second device, responsive to receiving the calling instruction, may execute the operations and/or flows in any embodiment of the method for processing a laser radar based sparse depth map, or the method for training a neural network, or the method for intelligently controlling a vehicle, or a method for obstacle-avoiding navigation.

The embodiments in the specification are described progressively. Each embodiment attaches importance to describing differences with other embodiments. Various embodiments may refer to one another for same or similar portion. The description of system embodiments is relatively simple because they substantially correspond to the method embodiments, and the related parts may refer to the description of the method embodiments.

The method, apparatus, electronic device and computer-readable storage medium in the embodiments of the disclosure may be implemented in various manners. For example, the method, apparatus, electronic device and computer-readable storage medium in the embodiments of the disclosure may be implemented through software, hardware, firmware or any combination thereof. The sequence of the operations of the method is only for description, and the operations of the method in the embodiments of the disclosure are not limited to the sequence described above, unless otherwise specified. In addition, In some implementations, the embodiments of the disclosure may also be implemented as a program recorded in a recording medium, and the program includes machine-readable instructions configured to implement the method according to the embodiments of the disclosure. Therefore, the embodiments of the disclosure further cover the recording medium storing the program configured to execute the method according to the embodiments of the disclosure.

The description of the embodiments of the disclosure are made for an exemplary and descriptive purpose, and are not exhaustive or intended to limit the embodiments of the disclosure to the disclosed form. Many modifications and variations are apparent to those of ordinary skill in the art. The implementations are selected and described to better describe the principle and practical application of the embodiments of the disclosure, and to enable those of ordinary skill in the art to understand the embodiments of the disclosure so as to further design various implementations suitable for specific purposes and with various modifications.

1. A method for processing a laser radar based sparse depth map, comprising:
inputting, into a neural network, the laser radar based sparse depth map; and
acquiring, by the neural network, at least two feature maps, each of a respective different scale, for the laser radar based sparse depth map, performing valid point feature fusion for each of the at least two feature maps of the different scales, and processing the at least two feature maps having subjected to the valid point feature fusion, to obtain a processed depth map, wherein a number of valid points in the processed depth map is greater than a number of valid points in the laser radar based sparse depth map.

2. The method of claim 1, wherein:
inputting, into the neural network, the laser radar based sparse depth map comprises: inputting, into the neural network, the laser radar based sparse depth map and a mask for the laser radar based sparse depth map, wherein the mask for the laser radar based sparse depth map is configured to indicate the valid points in the laser radar based sparse depth map;
the method further comprises: determining, according to the mask for the laser radar based sparse depth map, a mask for each of the at least two feature maps of the different scales; and
performing valid point feature fusion for each of the at least two feature maps of the different scales comprises: performing, according to the masks for the at least two feature maps of the different scales, valid point feature fusion for each of the at least two feature maps of the different scales.

3. The method of claim 2, wherein acquiring, by the neural network, the at least two feature maps of the different scales for the laser radar based sparse depth map comprises:
performing, by the neural network, sparse convolution on the laser radar based sparse depth map, to obtain a feature map for the laser radar based sparse depth map; and
performing scale conversion on the feature map for the laser radar based sparse depth map to obtain the at least two feature maps of the different scales, wherein the at least two feature maps of the different scales comprise: the feature map having not subjected to the scale conversion, and at least one feature map having subjected to the scale conversion.

4. The method of claim 2, wherein determining, according to the mask for the laser radar based sparse depth map, the masks for the at least two feature maps of the different scales comprises:
performing, by the neural network, sparse convolution on the mask for the laser radar based sparse depth map, to obtain a mask for a feature map for the laser radar based sparse depth map, and performing scale conversion on the mask for the feature map, to obtain a mask for each of the at least two feature maps.

5. The method of claim 1, wherein performing valid point feature fusion for each of the at least two feature maps of the different scales comprises:
performing, by the neural network, at least one level of valid point feature fusion, wherein
during the at least one level of valid point feature fusion, the neural network performs valid point feature fusion for each of a plurality of paths of feature maps of respective different scales; and
when the neural network performs a plurality of levels of valid point feature fusion, an output from a level of valid point feature fusion serves as an input for another level of valid point feature fusion immediately following the level of valid point feature fusion.

6. The method of claim 5, wherein the neural network performs scale conversion on a feature map output by the level of feature fusion, and the feature map having subjected to the scale conversion is provided for the another level of valid point feature fusion.

7. The method of claim 5, wherein when a number of paths of outputs from the level of valid point feature fusion is smaller than a number of paths of inputs for the another level of valid point feature fusion, one of the paths of outputs from the level of valid point feature fusion and a feature map in the path of output after subjecting to scale conversion both serve as inputs for the another level of valid point feature fusion.

8. The method of claim 5, wherein performing valid point feature fusion for each of the at least two feature maps of the different scales further comprises:
performing valid point feature fusion for at least two feature maps having subjected to valid point feature fusion, to form one feature map, wherein the formed feature map serves as an input for an immediately following level of valid point feature fusion; or
processing, by the neural network, the formed feature map, for output.

9. The method of claim 5, further comprising:
providing, to the neural network, an image having a same angle of view and a same size as the laser radar based sparse depth map, wherein the image comprises an image photographed by a photographic device; and
acquiring, by the neural network, at least one feature map of a scale for the image, wherein the at least one feature map of the scale for the image serves as an input for corresponding valid point feature fusion,
wherein the at least one feature map for the image is to be fused with a feature map for the laser radar based sparse depth map.

10. The method of claim 5, wherein when the valid point feature fusion comprises N paths of inputs and outputs, valid point feature fusion executed on an M^{th} path of input by the neural network comprises:
downsampling a feature map and mask in an N^{th} path of input,
performing sparse merging and convolution on the downsampled feature map and mask, and a feature map and mask in the M^{th} path of input, and
performing sparse convolution on the feature map and mask having subjected to the sparse merging and convolution, to form a feature map and mask having subjected to valid point feature fusion for an M^{th} path of output,
wherein a scale of the feature map in the N^{th} path of input is greater than a scale of the feature map in the M^{th} path of input, M is an integer greater than 0, and N is an integer greater than M.

11. The method of claim 10, wherein the valid point feature fusion executed on the N^{th} path of input by the neural network comprises:
performing sparse convolution on the feature map and mask in the N^{th} path of input;
performing convolution on the feature map and mask having subjected to valid point feature fusion in at least the M^{th} path of output, and performing sparse upsampling on the feature map and mask having subjected to the convolution; and
performing sparse addition on the feature map and mask having subjected to the sparse convolution in the N^{th} path, and the feature map and mask having subjected to the sparse upsampling in at least the M^{th} path, to form a feature map and mask having subjected to valid point feature fusion for an N^{th} path of output.

12. The method of claim 8, wherein processing, by the neural network, the formed feature map, for output comprises:
performing sparse addition on feature maps and masks having subjected to valid point feature fusion output by a final level of valid point feature fusion; and
performing convolution on a result of the sparse addition, to form a processed depth map.

13. The method of claim 9, wherein when the valid point feature fusion includes N paths of inputs and outputs, valid point feature fusion executed on an N^{th} path of input by the neural network comprises:
performing sparse merging and convolution on a feature map and mask in the N^{th} path of input and the feature map of the image;
performing convolution on a feature map and mask having subjected to valid point feature fusion in at least an M^{th} path of output, and performing sparse upsampling on the feature map and mask having subjected to the convolution; and
performing sparse addition on the feature map and mask having subjected to the sparse merging and convolution in the N^{th} path, and the feature map and mask having subjected to the sparse upsampling in at least the M^{th} path, to form a feature map and mask having subjected to valid point feature fusion for an N^{th} path of output, where M is an integer greater than 0, and N is an integer greater than M.

14. The method of claim 10, wherein the sparse merging and convolution comprises:
merging a first feature map and a second feature map in a channel dimension, performing convolution on the merged feature map, and performing element-wise multiplication on the feature map having subjected to the convolution and a reciprocal of a weight matrix to form a feature map having subjected to the sparse merging and convolution; and
acquiring a first product of a mask for the first feature map and a number of channels of the first feature map, acquiring a second product of a mask for the second feature map and a number of channels of the second feature map, performing convolution on a sum of the first and second products, forming the weight matrix according to a result of the convolution, and binarizing the weight matrix to form a mask for the feature map having subjected to sparse merging and convolution.

15. The method of claim 11, wherein the sparse addition comprises:
performing element-wise multiplication on a first feature map and a mask for the first feature map, performing element-wise multiplication on a second feature map and a mask for the second feature map, adding two results of the multiplication, and performing element-wise multiplication on a result of the addition and a reciprocal of a weight matrix to form a feature map having subjected to sparse addition; and
performing OR operation on the mask for the first feature map and the mask for the second feature map, to form a mask for the feature map having subjected to the sparse addition.

16. The method of claim 11, wherein the sparse upsampling comprises:
performing element-wise multiplication on a feature map and a mask for the feature map, and upsampling a result of the multiplication;
upsampling the mask for the feature map, and forming a weight matrix based on the upsampled mask;
performing element-wise multiplication on the upsampled feature map and a reciprocal of the weight matrix, to form a feature map having subjected to sparse addition; and
binarizing the weight matrix to form a mask for the feature map having subjected to the sparse addition.

17. The method of claim 1, wherein the neural network is obtained by training based on a laser radar based sparse depth map sample and labelled depth values of a filled depth map sample for the laser radar based sparse depth map sample.

18. The method of claim 1, further comprising at least one of:
generating, according to the processed depth map, an instruction or early warning prompt information for controlling a vehicle where a laser radar is located; or
generating, according to the processed depth map, an instruction or early warning prompt information for performing obstacle-avoiding navigation control for a robot where the laser radar is located.

19. An apparatus for processing a laser radar based sparse depth map, comprising:
a processor; and
a memory, configured to store instructions that, when being executed by the processor, cause the processor to carry out the following:
inputting, into a neural network, the laser radar based sparse depth map; and
acquiring, by the neural network, at least two feature maps, each of a respective different scale, for the laser radar based sparse depth map, performing valid point feature fusion for each of the at least two feature maps of the different scales, and processing the at least two feature maps having subjected to the valid point feature fusion, to obtain a processed depth map, wherein a number of valid points in the processed depth map is greater than a number of valid points in the laser radar based sparse depth map.

20. A non-transitory computer-readable storage medium having stored thereon computer programs that, when being executed by a computer, cause the computer to carry out the following:
inputting, into a neural network, a laser radar based sparse depth map; and
acquiring, by the neural network, at least two feature maps, each of a respective different scale, for the laser radar based sparse depth map, performing valid point feature fusion for each of the at least two feature maps of the different scales, and processing the at least two feature maps having subjected to the valid point feature fusion, to obtain a processed depth map, wherein a number of valid points in the processed depth map is greater than a number of valid points in the laser radar based sparse depth map.
